(19) United States
(12) Patent Application Publication
(10) Pub. No.: US 2024/0152768 A1
(43) Pub. Date: May 9, 2024

(54) EFFICIENT FEDERATED-LEARNING MODEL TRAINING IN WIRELESS COMMUNICATION SYSTEM

(71) Applicant: NOKIA TECHNOLOGIES OY, Espoo (FI)

(72) Inventors: Muhammad Majid BUTT, Palaiseau (FR); István Zsolt KOVÁCS, Aalborg (DK)

(21) Appl. No.: 18/280,580

(22) PCT Filed: Apr. 1, 2022
(86) PCT No.: PCT/EP2022/058757

§ 371 Date: Sep. 6, 2023

Related U.S. Application Data
(60) Provisional application No. 63/184,363, filed on May 5, 2021.

(51) Int. Cl. G06N 3/098

(52) U.S. Cl. CPC G06N 3/098

(57) ABSTRACT

There are provided measures for enabling/realizing efficient model training, including model collection and/or aggregation, for federated learning, including hierarchical federated learning, in a wireless communication system. Such measures exemplarily comprise that a federated-learning training host configured for local model training decides on how to perform the local model training depending on availability of a cluster head and computation and communication costs for a federated-learning training task, and either locally performs the local model training or delegates at least part of a federated-learning training task to the cluster head. Also, such measures exemplarily comprise that a federated-learning training host configured for local model training computes a similarity metric between a locally computed set of local model parameters and each the received sets of local model parameters, and decides on whether to operate as a temporary cluster head for one or more federated-learning training hosts.

### FIELD

The present disclosure relates to efficient federated-learning model training in a wireless communication system. More specifically, the present disclosure relates to measures/mechanisms (including methods, apparatuses (i.e. devices, entities, elements and/or functions) and computer program products) for enabling/realizing efficient model training, including model collection and/or aggregation, for federated learning, including hierarchical federated learning, in a wireless communication system.

### BACKGROUND

Basically, the present disclosure relates to federated learning, particularly hierarchical federated learning, in a wireless communication system, e.g. a 3GPP-standardized wireless communication system, such as a 5G/NG system. Also, the present disclosure relates to application/utilization of clustering (of local learners hereinafter referred to as THs or DTHs) for/in federated-learning model training in such a wireless communication system.

While federated learning has already been applied in other fields, it recently became an increasing topic in wireless communication systems (i.e. mobile networks).

In wireless communication systems (i.e. mobile networks), there are applications and/or use case, typically hosted implemented at centralized nodes, requiring a large amount of model parameter data from multiple distributed nodes like UEs to be used to train a single common model (herein also referred to as global model). To minimize the data exchange between the distributed nodes where the data is generated and the centralized nodes where a common model needs to be created, the concept of federated learning (FL) can beneficially be applied. It is to be noted that a machine learning (ML) model is meant when herein reference is made to a model.

Federated learning (FL) is a form of machine learning where, instead of model training at a single node (e.g. a centralized node), different versions of the model are trained at the different distributed hosts based on their individual training data sets. This is different from distributed machine learning, where a single model is trained at distributed nodes by using computation power of the different distributed nodes. In other words, federated learning is different from distributed machine learning in the sense that: 1) each distributed node in a federated-learning scenario has its own local data which may not come from the same distribution, source or origin as the data at other nodes, 2) each node computes model parameters for its local model, and 3) a centralized node such as a central host does not compute a version or part of the model but combines (or aggregates) model parameters of all or at least some of the distributed models of the distributed nodes to generate a common model. The objective of this approach is to keep the training data set where it is generated and perform the model training locally at each individual learner (i.e. distributed node) in the federation.

After training a local model, each individual learner, which may herein be called Distributed Training Host (DTH), transfers its local model parameters, instead of its raw training data set, to an aggregating unit (at a centralized node), which may herein be called Meta Training Host (MTH). The MTH utilizes the local model parameters to update a global model which may eventually be fed back (as partial or partially aggregated global model) to the DTHs for further iterations until the global model converges, i.e. a convergence condition is satisfied. As a result, each DTH benefits from the data sets of the other DTHs only through the global model, shared by the MTH, without explicitly accessing a high volume of privacy-sensitive data available at each of the other DTHs.

In each round or instance of model collection from the DTHs, a large amount of model parameter data is transferred from the DTHs to the MTH, which consumes a lot of network resources, besides computation and communication power of the DTHs themselves. Therefore, it is important to design and use communication-efficient model collection schemes that can reduce the load on communication links by allowing more processing on the edges, i.e. the DTHs.

In each round or instance of model collection from the DTHs, each local model contributes towards the aggregated model, so for each round or instance of model aggregation, the MTH only updates the aggregated model after collecting locally trained models from all or at least some of the DTHs. This process could suffer from the following dilemmas:
The computational power or battery energy of the DTHs is not always high and the same; and some of the DTHs may struggle to update their local models, called stragglers in FL terminology. Getting models from all the required DTHs within a latency budget is therefore not always feasible, as stragglers may delay the final model aggregation at the MTH.
Besides local computation, model transfer consumes energy (communication power) in model transmission towards the MTH. Particularly, DTHs in deep neural networks may transfer a few hundreds to millions parameters for a local update. If DTHs (which in the case of wireless communication nodes are typically battery-powered UEs) consume all of their energy in computation and communication, they may run out of energy and will not be able to collect important data (and/or perform other FL tasks, radio tasks, or the like). This adds to the problem as the data in federated learning could not be independently and identically distributed (iid), and the aggregated model at the MTH will be missing data from the DTHs which are not able to sense and transfer data due to low energy or computational power.

Therefore, it is important to design and use not only communication-efficient but also power/energy-efficient model collection schemes taking into account both communication constraints and constraints in computational power and/or energy of the DTHs to complete a local model transfer in federated learning without affecting the convergence of global model aggregation.

Therefore, there is a desire/need for a solution for (enabling/realizing) efficient model training, including model collection and/or aggregation, for federated learning, including hierarchical federated learning, in a wireless communication system.

### SUMMARY

Various exemplifying embodiments of the present disclosure aim at addressing at least part of the above issues and/or problems and drawbacks.

Various aspects of exemplifying embodiments of the present disclosure are set out in the appended claims.

According to a first basic aspect or concept, the present disclosure provides at least the following subject-matter.

According to an example aspect of the present disclosure, there is provided a method of (or, stated in other words, operable or for use in/by) a communication entity in a wireless communication system, which is configured to act as a federated-learning training host configured for local model training, the method comprising: deciding on how to perform federated-learning training depending on availability of a cluster head of a cluster of federated-learning training hosts and computation and communication costs for a federated-learning training task, and locally performing the local model training or delegating at least part of a federated-learning training task to the cluster head on the basis of the decision.

According to an example aspect of the present disclosure, there is provided an apparatus of (or, stated in other words, operable or for use in/by) a communication entity in a wireless communication system, which is configured to act as a federated-learning training host configured for local model training, the apparatus comprising at least one processor and at least one memory including computer program code, wherein the at least one processor, with the at least one memory and the computer program code, is configured to cause the apparatus to perform: deciding on how to perform federated-learning training depending on availability of a cluster head of a cluster of federated-learning training hosts and computation and communication costs for a federated-learning training task, and locally performing the local model training or delegating at least part of a federated-learning training task to the cluster head on the basis of the decision.

According to an example aspect of the present disclosure, there is provided an apparatus of (or, stated in other words, operable or for use in/by) a communication entity in a wireless communication system, which is configured to act as a federated-learning training host configured for local model training, the apparatus comprising: deciding circuitry configured to decide on how to perform federated-learning training depending on availability of a cluster head of a cluster of federated-learning training hosts and computation and communication costs for a federated-learning training task, and training circuitry configured to locally perform the local model training or delegate at least part of a federated-learning training task to the cluster head on the basis of the decision.

According to an example aspect of the present disclosure, there is provided a method of (or, stated in other words, operable or for use in/by) a communication entity in a wireless communication system, which is configured to act as a cluster head of a cluster of federated-learning training hosts each being configured for local model training, the method comprising: obtaining a delegation for performing at least part of a federated-learning training task for one or more federated-learning training hosts in the cluster, and performing the at least part of the federated-learning training task for the one or more federated-learning training hosts in the cluster based on the delegation.

According to an example aspect of the present disclosure, there is provided an apparatus of (or, stated in other words, operable or for use in/by) a communication entity in a wireless communication system, which is configured to act as a cluster head of a cluster of federated-learning training hosts each being configured for local model training, the apparatus comprising at least one processor and at least one memory including computer program code, wherein the at least one processor, with the at least one memory and the computer program code, is configured to cause the apparatus to perform: obtaining a delegation for performing at least part of a federated-learning training task for one or more federated-learning training hosts in the cluster, and performing the at least part of the federated-learning training task for the one or more federated-learning training hosts in the cluster based on the delegation.

According to an example aspect of the present disclosure, there is provided an apparatus of (or, stated in other words, operable or for use in/by) a communication entity in a wireless communication system, which is configured to act as a cluster head of a cluster of federated-learning training hosts each being configured for local model training, the apparatus comprising: obtaining circuitry configured to obtain a delegation for performing at least part of a federated-learning training task for one or more federated-learning training hosts in the cluster, and performing circuitry configured to perform the at least part of the federated-learning training task for the one or more federated-learning training hosts in the cluster based on the delegation.

According to an example aspect of the present disclosure, there is provided a method of (or, stated in other words, operable or for use in/by) a communication entity in a wireless communication system, which is configured to act as a central federated-learning training host configured for global model training for one or more clusters of federated-learning training hosts each being configured for local model training, the method comprising: collecting at least one of local model parameters of respective local models from one or more federated-learning training hosts and cluster model parameters of respective cluster models from one or more cluster heads of the clusters, a cluster model representing a joint local model for one or more federated-learning training hosts in a respective cluster, and aggregating a global model based on the collected at least one of local model parameters and cluster model parameters.

According to an example aspect of the present disclosure, there is provided an apparatus of (or, stated in other words, operable or for use in/by) a communication entity in a wireless communication system, which is configured to act as a central federated-learning training host configured for global model training for one or more clusters of federated-learning training hosts each being configured for local model training, the apparatus comprising at least one processor and at least one memory including computer program code, wherein the at least one processor, with the at least one memory and the computer program code, is configured to cause the apparatus to perform: collecting at least one of local model parameters of respective local models from one or more federated-learning training hosts and cluster model parameters of respective cluster models from one or more cluster heads of the clusters, a cluster model representing a joint local model for one or more federated-learning training hosts in a respective cluster, and aggregating a global model based on the collected at least one of local model parameters and cluster model parameters.

According to an example aspect of the present disclosure, there is provided an apparatus of (or, stated in other words, operable or for use in/by) a communication entity in a wireless communication system, which is configured to act as a central federated-learning training host configured for global model training for one or more clusters of federated-learning training hosts each being configured for local model training, the apparatus comprising: collecting circuitry configured to collect at least one of local model parameters of respective local models from one or more federated-learning training hosts and cluster model parameters of respective cluster models from one or more cluster heads of the clusters, a cluster model representing a joint local model for one or more federated-learning training hosts in a respective cluster, and aggregating circuitry configured to aggregate a global model based on the collected at least one of local model parameters and cluster model parameters.

According to an example aspect of the present disclosure, there is provided a computer program product comprising (computer-executable) computer program code which, when the program code is executed (or run) on a computer or the program is run on a computer (e.g. a computer of an apparatus according to any one of the aforementioned apparatus-related example aspect of the present disclosure), is configured to cause the computer to carry out the method according to the aforementioned method-related example aspect of the present disclosure.

The computer program product may comprise or may be embodied as a (tangible/non-transitory) computer-readable (storage) medium or the like, on which the computer-executable computer program code is stored, and/or the program is directly loadable into an internal memory of the computer or a processor thereof.

According to a second basic aspect or concept, the present disclosure provides at least the following subject-matter.

According to an example aspect of the present disclosure, there is provided a method of (or, stated in other words, operable or for use in/by) a communication entity in a wireless communication system, which is configured to act as a federated-learning training host configured for local model training, the method comprising: receiving a set of model parameters of a local model from each of one or more federated-learning training hosts, computing a similarity metric between a locally computed set of model parameters of a local model and each of the received sets of model parameters, deciding on whether to operate as a temporary cluster head for the one or more federated-learning training hosts, and communicating the computed similarity metric to a central federated-learning training host configured for global model training when it is decided to operate as the temporary cluster head.

According to an example aspect of the present disclosure, there is provided an apparatus of (or, stated in other words, operable or for use in/by) a communication entity in a wireless communication system, which is configured to act as a federated-learning training host configured for local model training, the apparatus comprising at least one processor and at least one memory including computer program code, wherein the at least one processor, with the at least one memory and the computer program code, is configured to cause the apparatus to perform: receiving a set of model parameters of a local model from each of one or more federated-learning training hosts, computing a similarity metric between a locally computed set of model parameters of a local model and each of the received sets of model parameters, deciding on whether to operate as a temporary cluster head for the one or more federated-learning training hosts, and communicating the computed similarity metric to a central federated-learning training host configured for global model training when it is decided to operate as the temporary cluster head.

According to an example aspect of the present disclosure, there is provided an apparatus of (or, stated in other words, operable or for use in/by) a communication entity in a wireless communication system, which is configured to act as a federated-learning training host configured for local model training, the apparatus comprising: receiving circuitry configured to receive a set of model parameters of a local model from each of one or more federated-learning training hosts, computing circuitry configured to compute a similarity metric between a locally computed set of model parameters of a local model and each of the received sets of model parameters, deciding circuitry configured to decide on whether to operate as a temporary cluster head for the one or more federated-learning training hosts, and communicating circuitry configured to communicate the computed similarity metric to a central federated-learning training host configured for global model training when it is decided to operate as the temporary cluster head.

According to an example aspect of the present disclosure, there is provided a method of (or, stated in other words, operable or for use in/by) a communication entity in a wireless communication system, which is configured to act as a federated-learning training host configured for local model training, the method comprising: computing a set of model parameters of a local model, and broadcasting the computed set of model parameters.

According to an example aspect of the present disclosure, there is provided an apparatus of (or, stated in other words, operable or for use in/by) a communication entity in a wireless communication system, which is configured to act as a federated-learning training host configured for local model training, the apparatus comprising at least one processor and at least one memory including computer program code, wherein the at least one processor, with the at least one memory and the computer program code, is configured to cause the apparatus to perform: computing a set of model parameters of a local model, and broadcasting the computed set of model parameters.

According to an example aspect of the present disclosure, there is provided an apparatus of (or, stated in other words, operable or for use in/by) a communication entity in a wireless communication system, which is configured to act as a federated-learning training host configured for local model training, the apparatus comprising: computing circuitry configured to compute a set of model parameters of a local model, and broadcasting circuitry configured to broadcast the computed set of model parameters.

According to an example aspect of the present disclosure, there is provided a method of (or, stated in other words, operable or for use in/by) a communication entity in a wireless communication system, which is configured to act as a central federated-learning training host configured for global model training for a set of preselected federated-learning training hosts each being configured for local model training, the method comprising: receiving a similarity metric, indicating a similarity between local model parameters of a number of federated-learning training hosts, from one or more federated-learning training hosts representing temporary cluster heads out of the set of preselected federated-learning training hosts, generating a similarity map for the set of preselected federated-learning training hosts based on the received one or more similarity metrics, and selecting one or more federated-learning training hosts as cluster heads for collecting local model parameters based on the generated similarity map.

According to an example aspect of the present disclosure, there is provided an apparatus of (or, stated in other words, operable or for use in/by) a communication entity in a wireless communication system, which is configured to act as a central federated-learning training host configured for global model training for a set of preselected federated-learning training hosts each being configured for local model training, the apparatus comprising at least one processor and at least one memory including computer program code, wherein the at least one processor, with the at least one memory and the computer program code, is configured to cause the apparatus to perform: receiving a similarity metric, indicating a similarity between local model parameters of a number of federated-learning training hosts, from one or more federated-learning training hosts representing temporary cluster heads out of the set of preselected federated-learning training hosts, generating a similarity map for the set of preselected federated-learning training hosts based on the received one or more similarity metrics, and selecting one or more federated-learning training hosts as cluster heads for collecting local model parameters based on the generated similarity map.

According to an example aspect of the present disclosure, there is provided an apparatus of (or, stated in other words, operable or for use in/by) a communication entity in a wireless communication system, which is configured to act as a central federated-learning training host configured for global model training for a set of preselected federated-learning training hosts each being configured for local model training, the apparatus comprising: receiving circuitry configured to receive a similarity metric, indicating a similarity between local model parameters of a number of federated-learning training hosts, from one or more federated-learning training hosts representing temporary cluster heads out of the set of preselected federated-learning training hosts, generating circuitry configured to generate a similarity map for the set of preselected federated-learning training hosts based on the received one or more similarity metrics, and selecting circuitry configured to select one or more federated-learning training hosts as cluster heads for collecting local model parameters based on the generated similarity map.

According to an example aspect of the present disclosure, there is provided a computer program product comprising (computer-executable) computer program code which, when the program code is executed (or run) on a computer or the program is run on a computer (e.g. a computer of an apparatus according to any one of the aforementioned apparatus-related example aspect of the present disclosure), is configured to cause the computer to carry out the method according to the aforementioned method-related example aspect of the present disclosure.

The computer program product may comprise or may be embodied as a (tangible/non-transitory) computer-readable (storage) medium or the like, on which the computer-executable computer program code is stored, and/or the program is directly loadable into an internal memory of the computer or a processor thereof.

Further developments and/or modifications of the aforementioned exemplary aspects of the present disclosure are set out in the following.

By way of exemplifying embodiments of the present disclosure, efficient model training, including model collection and/or aggregation, for federated learning, including hierarchical federated learning, in a wireless communication system, can be enabled/realized.

### BRIEF DESCRIPTION OF THE DRAWINGS

In the following, the present disclosure will be described in greater detail by way of non-limiting examples with reference to the accompanying drawings, in which

FIG. 1 shows a schematic illustration of a hierarchical configuration of nodes in a federated-learning framework according to at least one exemplifying embodiment,

FIG. 2 shows a flowchart illustrating an example of a method/process according to at least one exemplifying embodiment,

FIG. 3 shows a flowchart illustrating an example of a method/process according to at least one exemplifying embodiment,

FIG. 4 shows a flowchart illustrating an example of a method/process according to at least one exemplifying embodiment,

FIG. 5 shows a flowchart illustrating an example of a method/process according to at least one exemplifying embodiment,

FIG. 6 shows a flowchart illustrating an example of a method/process according to at least one exemplifying embodiment,

FIG. 7 shows a schematic diagram illustrating an example of clustering-based network configuration and operation according to at least one exemplifying embodiment,

FIG. 8 shows a sequence diagram illustrating an example of a procedure according to at least one exemplifying embodiment,

FIG. 9 shows a sequence diagram illustrating an example of a procedure according to at least one exemplifying embodiment,

FIG. 10 shows a sequence diagram illustrating an example of a procedure according to at least one exemplifying embodiment,

FIG. 11 shows a schematic diagram illustrating an example of clustering-based network configuration and operation according to at least one exemplifying embodiment,

FIG. 12 shows a sequence diagram illustrating an example of a procedure according to at least one exemplifying embodiment,

FIG. 13 shows a sequence diagram illustrating an example of a procedure according to at least one exemplifying embodiment,

FIG. 14 shows a sequence diagram illustrating an example of a procedure according to at least one exemplifying embodiment,

FIG. 15 shows a schematic illustration of a hierarchical configuration of nodes in a federated-learning framework according to at least one exemplifying embodiment,

FIG. 16 shows a flowchart illustrating an example of a method/process according to at least one exemplifying embodiment,

FIG. 17 shows a flowchart illustrating an example of a method/process according to at least one exemplifying embodiment,

FIG. 18 shows a flowchart illustrating an example of a method/process according to at least one exemplifying embodiment,

FIG. 19 shows a flowchart illustrating an example of a method/process according to at least one exemplifying embodiment,

FIG. 20 shows a flowchart illustrating an example of a method/process according to at least one exemplifying embodiment,

FIG. 21 shows a flowchart illustrating an example of a method/process according to at least one exemplifying embodiment,

FIG. 22 shows a schematic diagram illustrating an example of network configuration and operation in a first stage of a procedure according to at least one exemplifying embodiment,

FIG. 23 shows a schematic diagram illustrating an example of network configuration and operation in a second stage of a procedure according to at least one exemplifying embodiment,

FIG. 24 shows a schematic diagram illustrating an example of network configuration and operation in a third stage of a procedure according to at least one exemplifying embodiment,

FIG. 25 shows a schematic diagram illustrating an example of network configuration and operation in a fourth stage of a procedure according to at least one exemplifying embodiment,

FIG. 26 shows a schematic diagram illustrating an example of a structure of apparatuses according to at least one exemplifying embodiment,

FIG. 27 shows a schematic diagram illustrating an example of a structure of apparatuses according to at least one exemplifying embodiment, and

FIG. 28 shows a schematic diagram illustrating an example of a structure of apparatuses according to at least one exemplifying embodiment.

### DETAILED DESCRIPTION

The present disclosure is described herein with reference to particular non-limiting examples and to what are presently considered to be conceivable (examples of) embodiments. A person skilled in the art will appreciate that the present disclosure is by no means limited to these examples and embodiments, and may be more broadly applied.

It is to be noted that the following description mainly refers to specifications being used as non-limiting examples for certain exemplifying network configurations and system deployments. Namely, the following description mainly refers to 3GPP standards, including 5G/NG standardization, being used as non-limiting examples. As such, the description of exemplifying embodiments given herein specifically refers to terminology which is directly related thereto. Such terminology is only used in the context of the presented non-limiting examples and embodiments, and does naturally not limit the present disclosure in any way. Rather, any other system configuration or deployment may equally be utilized as long as complying with what is described herein and/or exemplifying embodiments described herein are applicable to it.

Hereinafter, various exemplifying embodiments and implementations of the present disclosure and its aspects are described using several variants and/or alternatives. It is generally to be noted that, according to certain needs and constraints, all of the described variants and/or alternatives may be provided alone or in any conceivable combination (also including combinations of individual features of the various variants and/or alternatives). In this description, the words “comprising” and “including” should be understood as not limiting the described exemplifying embodiments and implementations to consist of only those features that have been mentioned, and such exemplifying embodiments and implementations may also contain features, structures, units, modules etc. that have not been specifically mentioned.

In the drawings, it is to be noted that lines/arrows interconnecting individual blocks or entities are generally meant to illustrate an operational coupling there-between, which may be a physical and/or logical coupling, which on the one hand is implementation-independent (e.g. wired or wireless) and on the other hand may also comprise an arbitrary number of intermediary functional blocks or entities not shown. In flowcharts or sequence diagrams, the illustrated order of operations or actions is generally illustrative/exemplifying, and any other order of respective operations or actions is equally conceivable, if feasible.

According to exemplifying embodiments of the present disclosure, in general terms, there are provided measures/mechanisms (including methods, apparatuses (i.e. devices, entities, elements and/or functions) and computer program products) for enabling/realizing efficient model training, including model collection and/or aggregation, for federated learning, including hierarchical federated learning, in a wireless communication system.

Generally, exemplifying embodiments of the present disclosure are directed to federated learning, particularly hierarchical federated learning, in a wireless communication system, e.g. a 3GPP-standardized wireless communication system, such as a 5G/NG system.

As outlined above, federated learning is generally an iterative process/approach in which a global model is gradually/iteratively aggregated by the use of local models, i.e. their recent state or their recent model parameters. Accordingly, any one of the subsequently described methods, processes or procedures are related to one round or instance of model collection/aggregation, and such methods, processes or procedures are repeated in the overall global model generation/aggregation. When synchronous model collection is applied, the respective methods, processes or procedures are executed in each round of model collection, i.e. upon a periodic or time-based initiation by a central host. When asynchronous model collection is applied, the respective methods, processes or procedures are executed in each instance of model collection, i.e. upon an event-based trigger by a central host. That is, the subsequently described methods, processes or procedures are equally applicable for synchronous and asynchronous model collection and aggregation, and may be performed in or as part of a model collection round or instance, event or operation, respectively.

Further, it is evident for the person skilled in the art that model training basically comprises computation or updating of model parameters and transfer/communication of the thus computed or updated model parameters, i.e. the computed or updated model. Specifically, local mode training at a DTH comprises local model update and transfer of the updated local model towards the MTH. Herein, a cluster model may be trained at a cluster head, including cluster model update or generation and transfer of the updated or generated cluster model towards the MTH.

Herein, any task in the context of (model learning in) federated learning, i.e. federated-learning training, may be referred to as a federated-learning training task. Such federated-learning training task may comprise one or more of model (parameter/s) computation or updating or averaging and transfer/communication of the thus computed or updated or averaged model (parameter/s).

Hereinafter, a first basic aspect or concept of enabling/realizing efficient federated-learning model training in a wireless communication system is described. This first basic aspect or concept basically refers to clustering-based hierarchical federated learning model training.

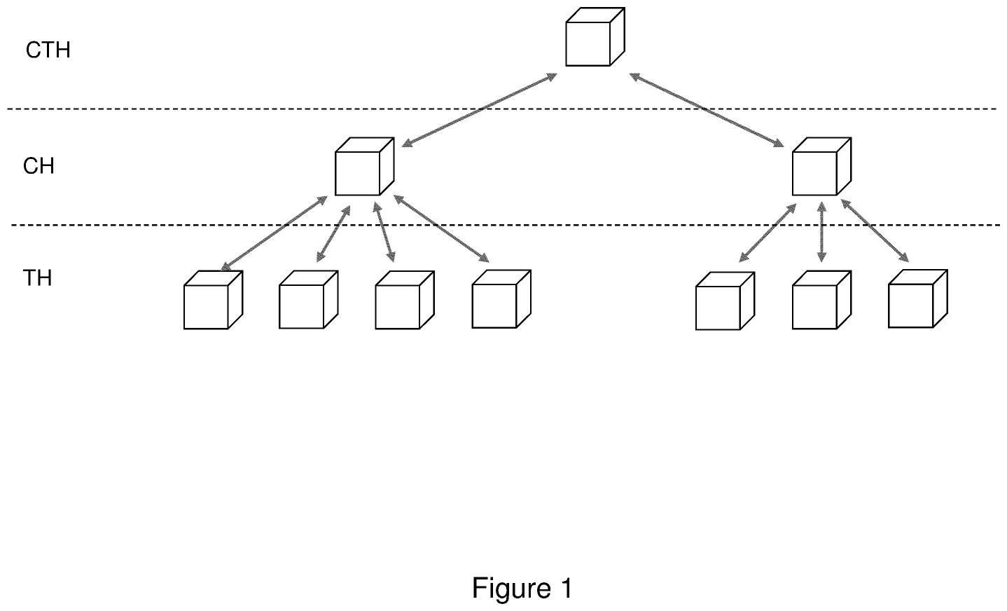

FIG. 1 shows a schematic illustration of a hierarchical configuration of nodes in a federated-learning framework according to at least one exemplifying embodiment. It is to be noted that FIG. 1 represents an exemplary illustration only such that the number and arrangement of the individual hosts/nodes is not limited to the illustrated scenario.

As shown in FIG. 1, a hierarchical configuration is composed of a lower level of one or more federated-learning training hosts referred to as training hosts (TH), an intermediate level of one or more federated-learning training hosts referred to as cluster heads (CH), and an upper level of a central federated-learning training host referred to as central training host (CTH). The THs are assumed to be arranged or organized in clusters, each cluster having one cluster head CH.

Any one of the federated-learning training hosts is hosting a training of a machine-learning model in the federated-learning framework. For example, a local model is respectively learned at/by each TH and possibly each CH, and a global model is learned at/by the CTH. Accordingly, the THs and CHs may represent Distributed Training Hosts (DTHs), and the CTH may represent a Meta Training Host (MTH).

The arrows in FIG. 1 represent communication links between the individual hosts/nodes. Accordingly, the THs are communicable with their respective CH, and each CH is communicable with the CTH. Although not shown in FIG. 1, there are typically also communication links such that the THs are directly communicable with the CTH (without involving the CH), respectively. The TH-CH communication links may be device-to-device (D2D) and/or sidelink communication links or may be radio network (RAN) links, i.e. enabling a one-to-one communication, irrespective of its implementation. The CH-CTH communication links may be typical radio network (RAN) links.

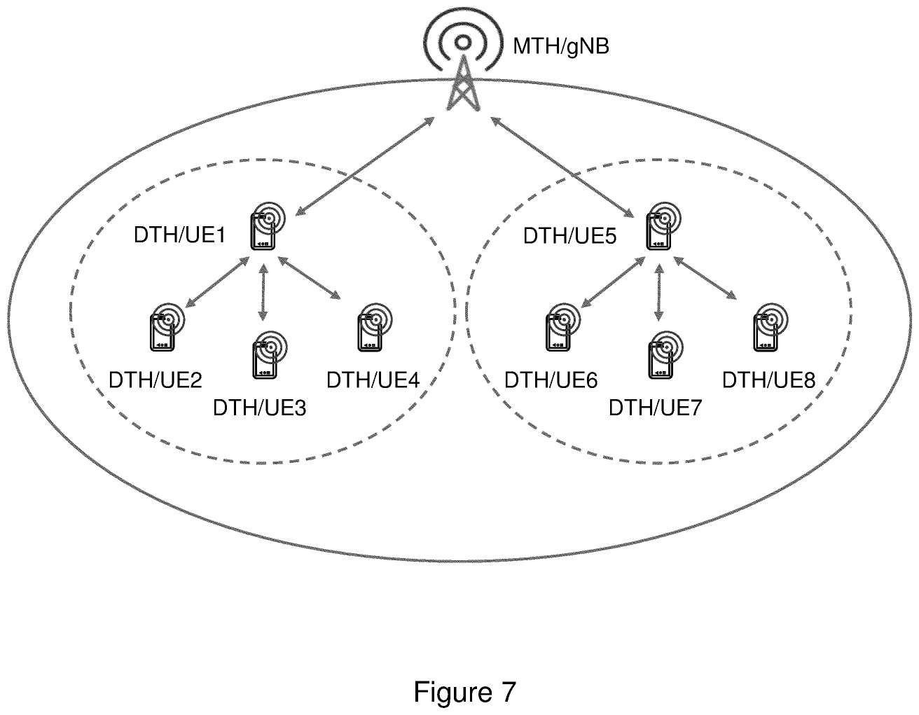

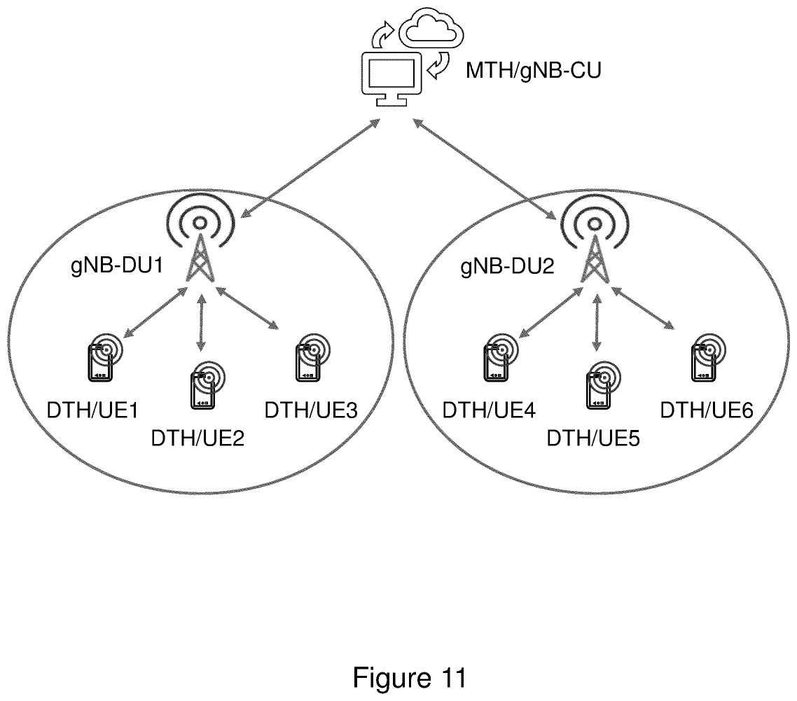

For potential implementations of the thus illustrated hierarchical configuration, reference is made to the description of FIGS. 7 and 11 below.

According to exemplifying embodiments, it is or may be assumed that THs (or DTHs) in a cluster trust each other and are allowed to share data. As an example, this can be assumed to be particularly true for private networks in 5G/NR where many nodes under the same personal network can trust each other and share data. At the beginning of each synchronous local model collection round or at the beginning of each asynchronous local model collection instance, one entity in a cluster is marked as cluster head. This entity, such as TH (or DTH), could be the entity with sufficient computation/communication power and battery resource to perform at least part of the local model training tasks of the THs (or DTHs) in the cluster, such as e.g. joint local model update and/or averaging on data of multiple THs (or DTHs). In different rounds or instances, THs (or DTHs) could but do not need to take turn to be the cluster head.

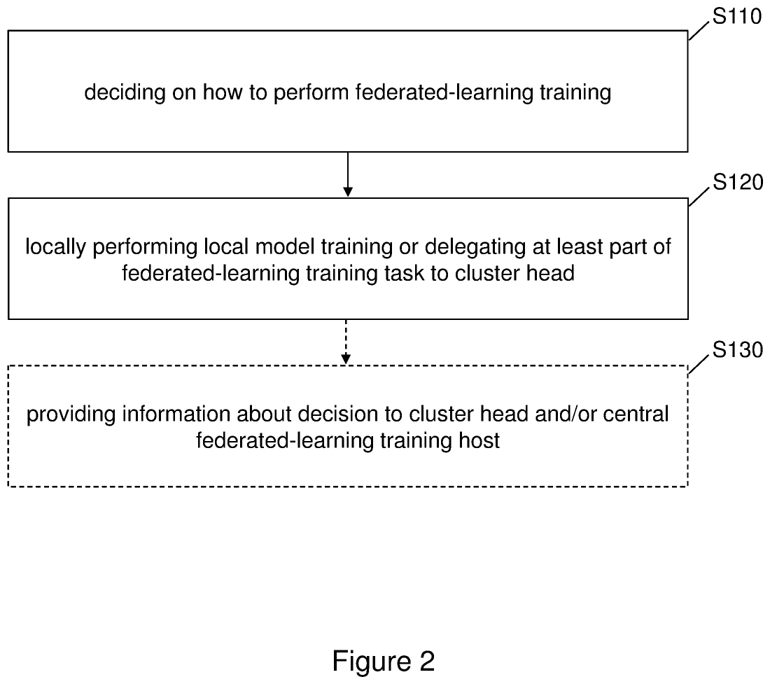

FIG. 2 shows a flowchart illustrating an example of a method/process according to at least one exemplifying embodiment. The method/process of FIG. 2 is a method/process of (or, stated in other words, operable or for use in/by) a communication entity in a wireless communication system, which is configured to act as a federated-learning training host configured for local model training, such as a DTH or a TH of FIG. 1.

As shown in FIG. 2, the method/process comprises an operation (S110) of deciding on how to perform federated-learning training depending on availability of a cluster head of a cluster of federated-learning training hosts and computation and communication costs for a federated-learning training task, and an operation (S120) of locally performing the local model training or delegating at least part of a federated-learning training task to the cluster head (such as a CH of FIG. 1) on the basis of the decision (of the deciding operation).

Optionally, as indicated by dashed lines, the method/process may also comprise, either before or after the performing/delegating operation (S120), an operation (S130) of providing an information about the decision (of the deciding operation) to at least one of the cluster head (such as a CH of FIG. 1) and a central federated-learning training host configured for global model training (such as the CTH of FIG. 1).

According to at least one exemplifying embodiment, the local performing of the local model training may comprise local model (parameter) computation or updating (using a local data set for local model training) and communication/transfer of the thus computed or updated model (parameter/s) to the central federated-learning training host.

According to at least one exemplifying embodiment, the delegating (in the delegating operation) may comprise one or more of delegating, to the cluster head, cluster model computation and cluster model communication to the central federated-learning training host (hereinafter also referred to as first type delegation), and delegating, to the cluster head, cluster model parameter averaging and cluster model communication to the central federated-learning training host (hereinafter also referred to as second type delegation). In the first type delegation, a local data set for local model training is communicated to the cluster head, preferably via device-to-device (D2D) and/or sidelink communication. In the second type delegation, model parameters of a local model are locally computed and the computed model parameters are communicated to the cluster head, preferably via device-to-device (D2D) and/or sidelink communication.

According to at least one exemplifying embodiment, the deciding (in the deciding operation) may be based on one or more of various parameters and/or conditions. Such parameters and/or conditions may for example include one or more of availability of a cluster head, availability of a trusted cluster, presence/verification of predefined level of trust for mutual data sharing, computation costs, communication costs, or the like.

As one example, the deciding may comprise determining whether the cluster head is available, and the local model training may be locally performed when the cluster head is not available. In this regard, the cluster head may be determined to be available when the cluster of federated-learning training hosts exists, in which said communication entity (which performs the method/process) is a cluster member as one of the federated-learning training hosts, and a communication entity acting as the cluster head is reachable for said communication entity.

As one example, the deciding may comprise comparing the computation and communication costs for local training with the computation and communication costs for delegation, and the local model training may be locally performed when the computation and communication costs for local training are equal or lower, or at least part of the federated-learning training task may be delegated to the cluster head when the computation and communication costs for delegation are lower. In this regard, the computation and communication costs for a federated-learning training task may comprise computation and communication costs for local training and computation and communication costs for delegation, wherein the computation and communication costs for local training comprise a sum of a cost for computing model parameters of the local model (also denoted as cost C_{M}) and a cost for communicating the computed model parameters of the local model to the central federated-learning training host (also denoted as cost C_{DT}).

As one example, the deciding may comprise comparing first type delegation costs and second type delegation costs, and the first type delegation may be performed when the first type delegation costs are lower, or the second type delegation may be performed when the second type delegation costs are equal or lower. In this regard, the computation and communication costs for delegation may comprise the first type delegation costs, which comprise a cost for communicating a local data set for local model training to the cluster head (also denoted as cost C_{N}), and the second type delegation costs, which comprise a sum of the cost for computing model parameters of the local model (also denoted as cost C_{N}) and a cost for communicating the computed model parameters of the local model to the cluster head (also denoted as cost C_{P}), or a minimum of the first type delegation costs and the second type delegation costs.

According to at least one exemplifying embodiment, one or more of the aforementioned deciding options/variants may be arbitrarily combined, as appropriate (e.g. depending on preference, need, purpose, conditions, etc.).

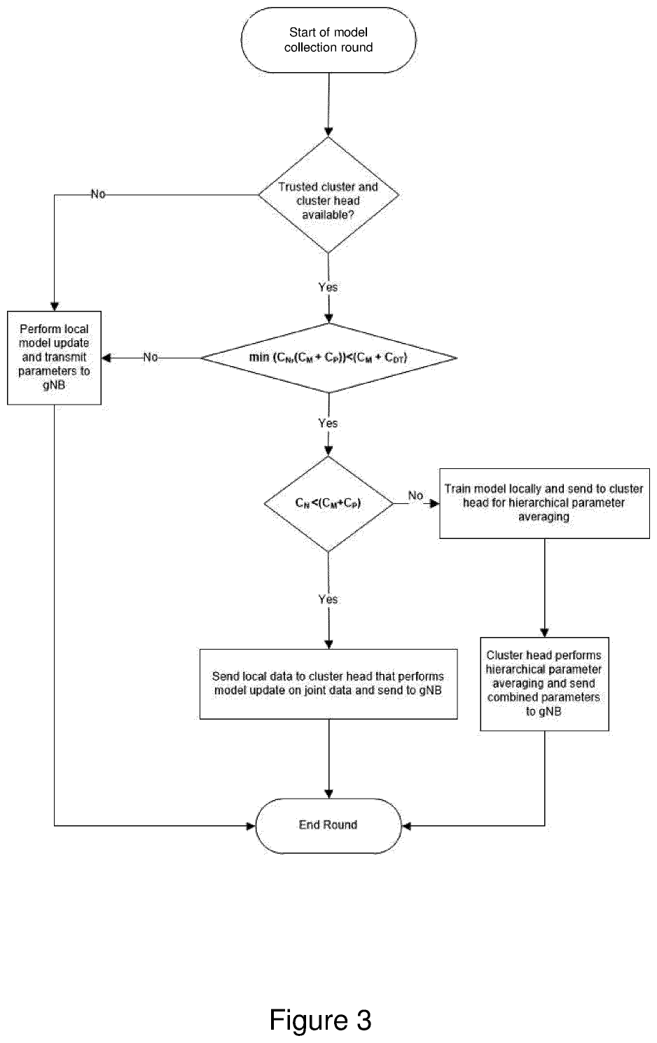

FIG. 3 shows a flowchart illustrating an example of a method/process according to at least one exemplifying embodiment. The method/process of FIG. 3 is a method/process of (or, stated in other words, operable or for use in/by) a communication entity in a wireless communication system, which is configured to act as a federated-learning training host configured for local model training, such as a DTH or a TH of FIG. 1. Specifically, this method/process may be performed as part of or in the context of the deciding operation (S110) of FIG. 1.

As shown in FIG. 3, the thus illustrated method/process comprises a combination of all of the aforementioned deciding options/variants. Hence, reference is made to the preceding description for details.

In view FIG. 3, the deciding operation (S110) of FIG. 1 according to at least one exemplifying embodiment may be performed along the lines of the following pseudo code representation.

If min(C_{N}, (C_{M}+C_{P}))<(C_{M}+C_{DT})) and cluster head (of trusted cluster) is available
Use cluster-based hierarchical method to compute and upload local models based on one of the following options
If C_{N}<(C_{M}+C_{P})
   Send local data (possibly after compression) to cluster head for data augmentation that performs joint local model update, i.e. perform first type delegation.
Else
   Compute local model parameters and send them for hierarchical averaging at cluster head, i.e. perform second type delegation.

Else
Do local model update and transmit model at uplink

It is to be noted that the first type delegation is particularly beneficial, effective or suited if the data size is small and the D2D communication path-loss is small, while the second type delegation is particularly beneficial, effective or suited if the number of nodes in a cluster is large and the mobile (cellular) network is congested and local averaging could reduce uplink traffic.

Irrespective of the above, the deciding may also be based on the level of trust for mutual data sharing, either alone or in combination with one or more of the aforementioned deciding options/variants. Namely, the local model training may be performed in case of low or no (sufficient) trust, wherein in this case said communication entity may also decide to not participate in a cluster of neighboring (untrusted) hosts or nodes, the first type delegation may be performed in case of high trust, and the second type delegation may be performed in case of medium trust.

It is to be noted that, if a DTH decides not to be part of cluster or use clustering for model update and transfer, it has the default option of local update and direct transfer of its local model to the MTH.

In view of the above-described approach, system/network capacities between nodes can be efficiently utilized. Particularly, if local training is provided at edge devices/nodes such as UEs, the UEs being limited in terms of energy and computational power, the UEs can use capabilities of some of the neighboring UEs to delegate, partially or completely, a federated-learning training task to the neighbor UEs (within a cluster) depending on certain conditions.

Thereby, a more efficient federated-learning model training (particularly a more efficient federated-learning model transfer/collection) may be achieved as compared to conventional federated-learning architecture, inherited from the parameter server design, which relies on highly centralized topologies and the assumption of large nodes-to-server bandwidths, which is, however, not ensured in real-world federated-learning scenarios where the network capacities between nodes may not be uniformly distributed and/or the size and contents of data (training) sets at the distributed nodes may not be uniform.

As outlined above, according to at least one exemplifying embodiment, the DTHs contributing to federated-learning training, i.e. FL model training, have one or more of the following options to contribute to federated learning or federated-learning training:

(1) Local model training: The DTHs compute their local model updates and send them directly to the MTH (via synchronous or asynchronous model collection). As mentioned above, the energy cost of computation is denoted by C_{M} and the cost of model transmission to the MTH is denoted as by C_{DT}.

(2) First type delegation: The DTHs could send their local data to a neighboring DTH, i.e. a cluster head, that collects data from (all of) the DTHs in the cluster and computes a joint local model (which may herein be referred to as cluster model). They could use a compression technique to send their data to the cluster head. As mentioned above, the cost of sending the data set to the neighboring DTH, i.e. the cluster head, is denoted as C_{N}. In this regard, it is important for all the DTHs in a cluster to have a trust model, i.e. they already have agreed to share data without loss of privacy.

(3) Second type delegation: The DTHs could train their local models locally but instead of sending models directly to the MTH, they send their computed parameters to a neighboring DTH, i.e. a cluster head, that collects parameters from (all of) the DTHs in the cluster and generated a joint local model (which may herein be referred to as cluster model) by averaging. Namely, the DTHs could use ‘hierarchical averaging’, wherein they send their model parameters to a node in a cluster (preferably using D2D communication) that performs averaging of parameters (e.g. using a federated averaging (FedAvg) or federated matched averaging (FedMA) algorithm) and sends only one set of parameters for the whole cluster to the MTH. For a cluster size of N nodes, only one set of parameters is transmitted, thereby reducing communication (in the uplink direction) on the mobile (cellular) network by N times. As mentioned above, the cost of sending trained local parameters to a neighboring node, i.e. the cluster head, is denoted as C_{P}.

According to at least one exemplifying embodiment, the DTHs form clusters of nodes (as is illustrated in any one of FIGS. 1, 7 and 11) based on a trust model to share data/local parameters, though any other mechanism for clustering could be used as well. If some of the nodes do not agree to join any cluster, they can locally update their model and send it to the MTH, i.e. perform local model training, as a default option. In each round or instance of synchronous or asynchronous model collection, conditioned on availability of a cluster head, who is willing to perform more computationally intensive tasks, each DTH is allowed to delegate at least part of a federated-learning training task (which may be or relate to a task which should actually be performed by the DTH as part of federated-learning training), i.e. one or more computation and/or communication tasks, to one or more other DTHs, which may be based on computation resources dedicated for local FL model training and/or computation and communication costs. Thus, a decision at/by each DTH may be a function f(Cost_vector, E) where for example Cost_vector={C_{M}, C_{DT}, C_{N}, C_{P}} and E is the computational power available for model training.

On the one hand, joint model training on augmented data by many DTHs could help UEs with small computational power and energy to increase their sustainability by taking advantage of more computationally powerful DTHs. On the other hand, this policy requires less amount of data transfer on uplink as parameters for multiple nodes are either jointly optimized by one DTH or averaged, e.g. by using a federated averaging (FedAvg) or federated matched averaging (FedMA) algorithm, in the cluster, which is termed herein as hierarchical averaging. Moreover, if data is non-iid (i.e. not independently and identically distributed) across DTHs, a joint local update on data from several DTHs could help to make it (more) iid (i.e. independently and identically distributed) and help fast/er convergence of the aggregated global model.

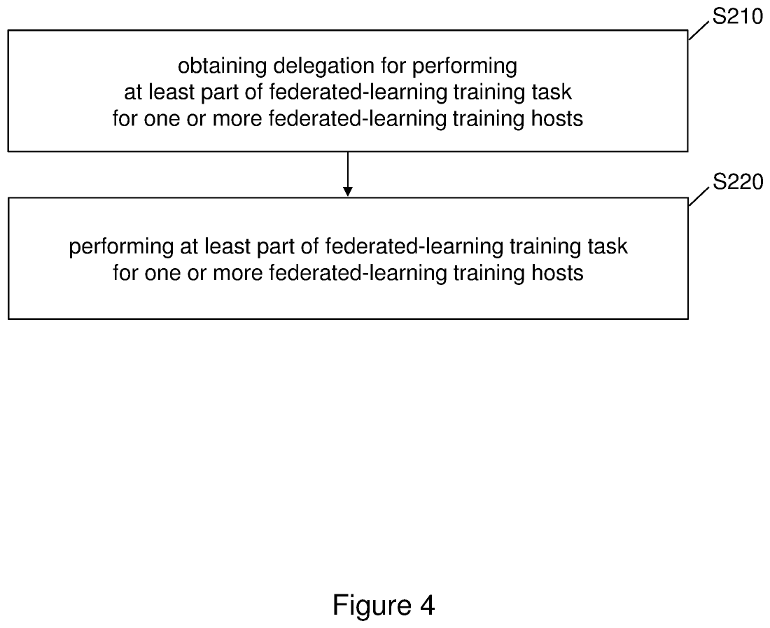

FIG. 4 shows a flowchart illustrating an example of a method/process according to at least one exemplifying embodiment. The method/process of FIG. 4 is a method/process of (or, stated in other words, operable or for use in/by) a communication entity in a wireless communication system, which is configured to act as a cluster head of a cluster of federated-learning training hosts each being configured for local model training, such as a CH of FIG. 1.

As shown in FIG. 4, the method/process comprises an operation (S210) of obtaining a delegation for performing at least part of a federated-learning training task for one or more federated-learning training hosts in the cluster, and an operation (S220) of performing the at least part of the federated-learning training task for the one or more federated-learning training hosts in the cluster based on the delegation.

According to at least one exemplifying embodiment, the obtaining may comprise receiving at least one of a local data set for local model training and computed model parameters of a local model from a respective federated-learning training host, preferably via device-to-device (D2D) and/or sidelink communication. The local data set may be received in case of a first type delegation, i.e. delegation for cluster model computation and cluster model communication to the central federated-learning training host. The computed model parameters may be obtained in case of a second type delegation, i.e. delegation for cluster model parameter averaging and cluster model communication to the central federated-learning training host. For details in this regard, especially in terms of the respective operations to be performed by the cluster head in the first or second type delegation, reference is made to be above explanations.

According to at least one exemplifying embodiment, the DTHs in a cluster may decide differently in their respective deciding operation. That is, one or more DTHs in the cluster may decide for the first type delegation, and one or more DTHs in the cluster may decide for the second type delegation. In this case, the cluster head may perform accordingly, namely a mixture or combination of the respective operations for the first and second type delegations.

Namely, a scenario may be considered, where some of the cluster members train their model locally and send model parameters to the cluster head for hierarchical averaging while other cluster members send their data for joint training at the cluster head. In this case, the cluster head first performs local computation of model on joint data and then performs hierarchical averaging by combining parameters from the other members of the cluster.

Here, when the obtained delegation comprise (a mixture or combination) delegation for cluster model computation and cluster model communication for a first subset of the federated-learning training hosts in the cluster and delegation for cluster model parameter averaging and cluster model communication to the central federated-learning training host for a second subset of the federated-learning training hosts in the cluster, the performing operation (S220) comprises computing model parameters for the first subset of federated-learning training hosts in the cluster based on the received local data sets, averaging the computed model parameters for the first subset of federated-learning training hosts in the cluster and the received computed model parameters for the second subset of federated-learning training hosts in the cluster for generating averaged model parameters of a cluster model representing a joint local model of the cluster, and communicating the averaged model parameters of the cluster model to the central federated-learning training host.

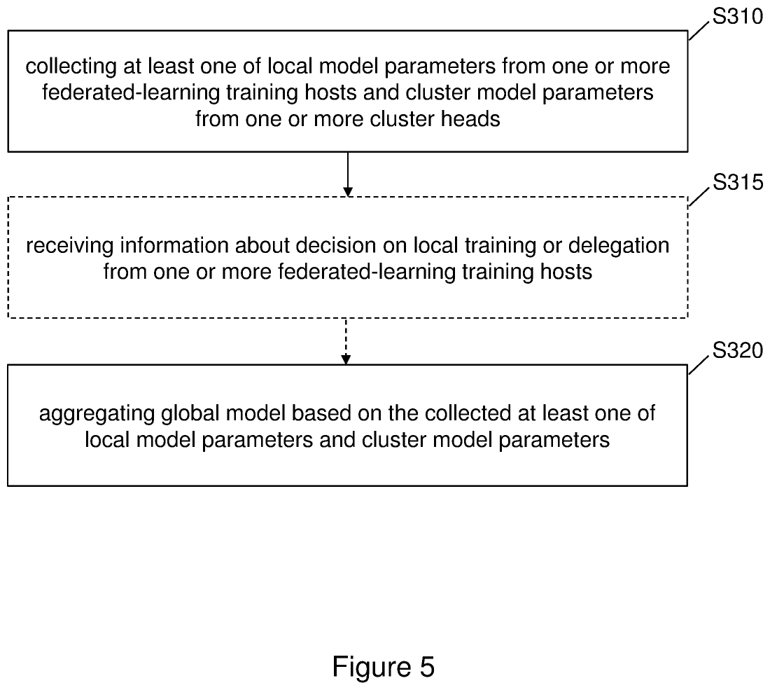

FIG. 5 shows a flowchart illustrating an example of a method/process according to at least one exemplifying embodiment. The method/process of FIG. 5 is a method/process of (or, stated in other words, operable or for use in/by) a communication entity in a wireless communication system, which is configured to act as a central federated-learning training host configured for global model training for one or more clusters of federated-learning training hosts each being configured for local model training, such as a MTH or CTH of FIG. 1.

As shown in FIG. 5, the method/process comprises an operation (S310) of collecting at least one of local model parameters of respective local models from one or more federated-learning training hosts and cluster model parameters of respective cluster models from one or more cluster heads of the clusters (a cluster model representing a joint local model for one or more federated-learning training hosts in a respective cluster), and an operation (S320) aggregating a global model based on the collected at least one of local model parameters and cluster model parameters.

Optionally, as indicated by dashed lines, the method/process may also comprise, either concurrently with or after the collecting operation (S310), an operation (S315) of receiving, from one or more federated-learning training hosts, an information about a decision on whether the local model training is locally performed or a federated-learning training task is at least partly delegated to a cluster head of a cluster, in which the respective federated-learning training host is a cluster member.

According to at least one exemplifying embodiment, this information may comprise one or more of: an identification of the cluster head when it is decided to delegate at least part of the federated-learning training task to the cluster head (i.e. in case of the first or second type delegation), an indication of a lack of necessity or desire of receiving an at least partially aggregated model when cluster model computation and cluster model communication is delegated to the cluster head (i.e. in case of the first type delegation), or an indication of necessity or desire of receiving an at least partially aggregated model when cluster model parameter averaging and cluster model communication is delegated to the cluster head (i.e. in case of the second type delegation).

According to at least one exemplifying embodiment, the method/process may further comprise providing an at least partially aggregated model to each federated-learning training host from which an indication of necessity or desire of receiving an at least partially aggregated model is received.

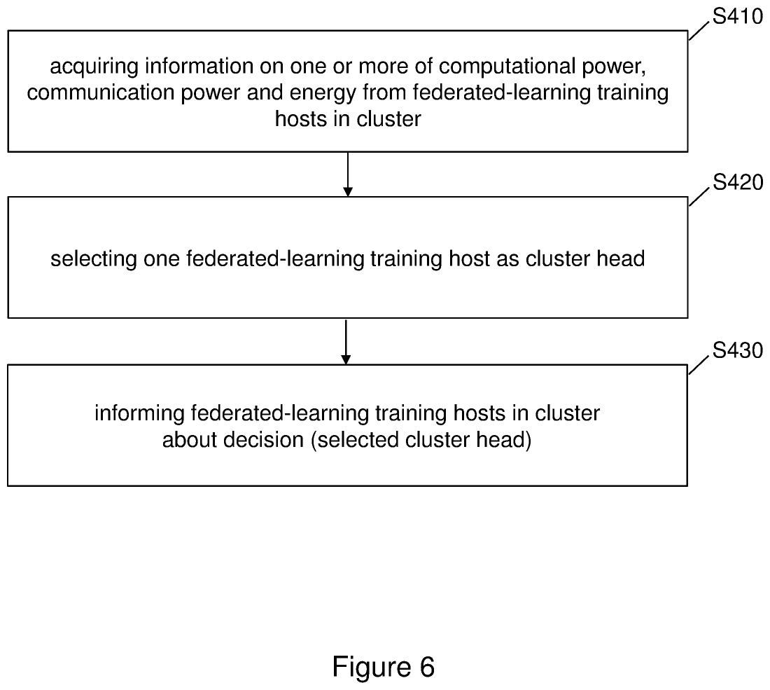

FIG. 6 shows a flowchart illustrating an example of a method/process according to at least one exemplifying embodiment. The method/process of FIG. 5 is a method/process of (or, stated in other words, operable or for use in/by) a communication entity in a wireless communication system, which is configured to act as a cluster head of a cluster of federated-learning training hosts each being configured for local model training, such as a CH of FIG. 1, or a method/process of (or, stated in other words, operable or for use in/by) a communication entity in a wireless communication system, which is configured to act as a central federated-learning training host configured for global model training for one or more clusters of federated-learning training hosts each being configured for local model training, such as a MTH or CTH of FIG. 1.

As shown in FIG. 6, the method/process comprises an operation (S410) of acquiring information on one or more of computational power, communication power and energy from federated-learning training hosts in cluster, an operation (S420) of selecting one federated-learning training host as cluster head, and an operation (S430) of informing federated-learning training hosts in a cluster about decision (selected cluster head).

According to various exemplifying embodiments, such cluster head selection may be implemented in different ways, using different parameters and/or conditions, at/by different entities, or the like.

For example, a cluster head selection method/process may be realized at/by an entity being configured/dedicated accordingly, i.e. an entity hosting the cluster selection, such as e.g. a gNB in a network configuration as illustrated in FIG. 7 or a gNB-CU or RIC in a network configuration as illustrated in FIG. 11, either initially or constantly, or may be realized at/by the existing/present cluster head in a cluster.

As one example, the cluster head selection may comprise the following steps (e.g. in an iterative manner):
(1) The DTHs report their computational power and battery energy.
(2) The competent entity selects the UEs with sufficiently high computational power and/or battery energy, such as Computational_Power>Threshhold_Power and/or Battery_Energy>Energy_Threshold.
(3) The competent entity selects, e.g. for the current round, the UE that has not been cluster head for the longest period from the UEs satisfying the above condition.
(4) The competent entity informs the thus selected cluster head and the other DTHs in the cluster about the selection, such as the ID of the selected cluster head.

In this approach, it is taken into consideration how long a node has not been cluster head before such that the burden of being cluster head is dispersed within the cluster based on a temporal approach.

As one example, the cluster head selection may comprise the following steps (e.g. in an iterative manner):
(1) The DTHs report their computational power and battery energy.
(2) The competent entity uses a weighting for calculating a selection index of each DTH, such as e.g. Head_index=w1*Computational_Power+w2*Battery_Energy.
(3) The competent entity selects, e.g. for the current round, the DTH with the largest selection index, i.e. Head_index, to be cluster head.
(4) The competent entity informs the thus selected cluster head and other DTHs in the cluster about the selection, such as the ID of the selected cluster head

In this approach, the priority of the existing/present cluster head naturally goes down in the next round, as Battery_Energy will go down for the cluster head after it performs joint model update/averaging for the whole cluster. Alternatively, if computational and/or communication resources among the nodes in the cluster are identical, a simple round robin cluster selection may be executed as well.

Any one of these approaches maintain some kind of fairness among the cluster heads, as the role of the cluster head can be switched based on objective criteria.

It is to be noted that, depending on certain conditions, the architecture or configuration, the system/network structure, or the like, it may be more or less desired or required to iteratively select and switch the role of the cluster heads. For example, switching the role of the cluster is (more) desirable or preferable in a network configuration as illustrated in FIG. 7 but is less or not desirable or preferable in a network configuration as illustrated in FIG. 11 (namely, in such network configuration, the role of the cluster head may be fixedly exercised by the gNB/gNB-DU with its cell corresponding to its served cluster).

Once cluster and cluster head are selected in a synchronous or asynchronous model collection round, each DTH uses the above-described method/process to decide its action, i.e. how to perform local update and transfer its model to the MTH.

FIG. 7 shows a schematic diagram illustrating an example of clustering-based network configuration and operation according to at least one exemplifying embodiment. It is to be noted that FIG. 7 represents an exemplary illustration only such that the number and arrangement of the individual hosts/nodes is not limited to the illustrated scenario.

As shown in FIG. 7, an implementation or use case of a hierarchical configuration, as illustrated in FIG. 1, in a wireless communication system may be such that a gNB, i.e. communication control element or function, represents or operates as MTH (corresponding to the CTH of FIG. 1), one or more UEs, i.e. communication elements or functions, represent or operate as DTHs (corresponding to the CHs of FIG. 1), and one or more UEs, i.e. communication elements or functions, represent or operate as DTHs (corresponding to the THs of FIG. 1).

While all of the thus exemplified DTHs/UEs (i.e. DTH/UE1 to DTH/UE8) are served by and located in the cell of the gNB, they form/constitute two clusters (indicated by dashed lines). DTH/UE1 to DTH/UE4 belong to one cluster, with DTH/UE1 being the cluster head and DTH/UE2 to DTH/UE4 being the cluster members, and DTH/UE5 to DTH/UE8 belong to another cluster, with DTH/UE5 being the cluster head and DTH/UE6 to DTH/UE8 being the cluster members.

In the clusters, the DTHs/UEs may communicate via device-to-device (D2D) and/or sidelink communication, and each of the cluster heads may communicate with the MTH via uplink/downlink communication (i.e. network-based communication), as illustrated by the arrows.

In such a network configuration, the methods/processes of FIGS. 2 and 3 may be realized/implemented at the UE (side), the method/process of FIG. 4 may be realized/implemented at the UE (side), and the method/process of FIG. 5 may be realized/implemented at the RAN (side). For realization or implementation of local model training according to one or more exemplifying embodiments, the network, such as the gNB, should be or even needs to be aware of the UE decision (local training or delegation) and provide required support.

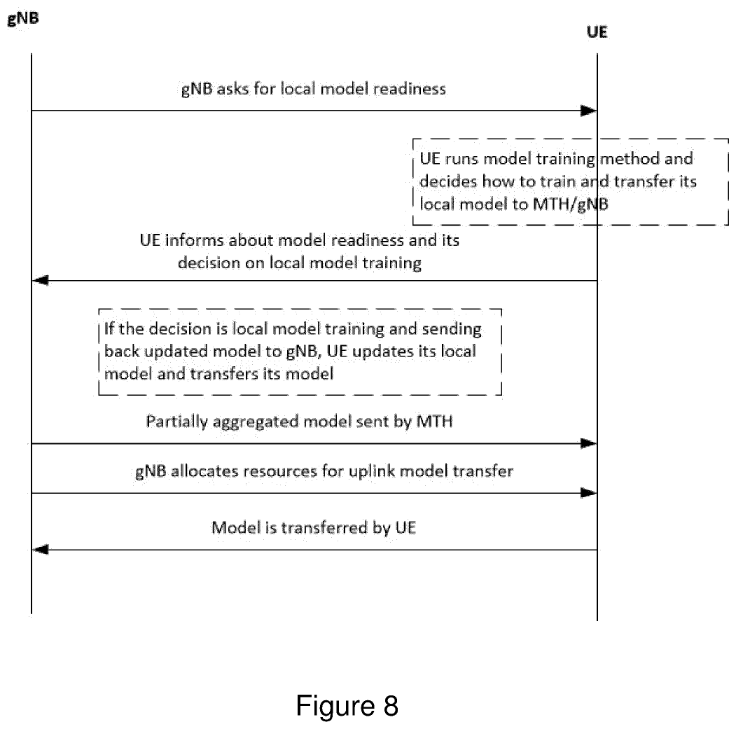

In the following, exemplary procedures are described, which are applicable in/for the clustering-based network configuration of FIG. 7. Namely, FIGS. 8 to 10 show exemplary operation and signaling/communication for the case that the UE acts as DTH, and the gNB acts as MTH.

In any one of FIGS. 8 to 10, a round or instance of model collection/aggregation is deemed to be initiated by the MTH by way of asking for local model readiness.

FIG. 8 shows a sequence diagram illustrating an example of a procedure according to at least one exemplifying embodiment. This procedure corresponds to a case in which the DTH/UE decides to perform local model training and locally performs model training (in the method/process of FIG. 2).

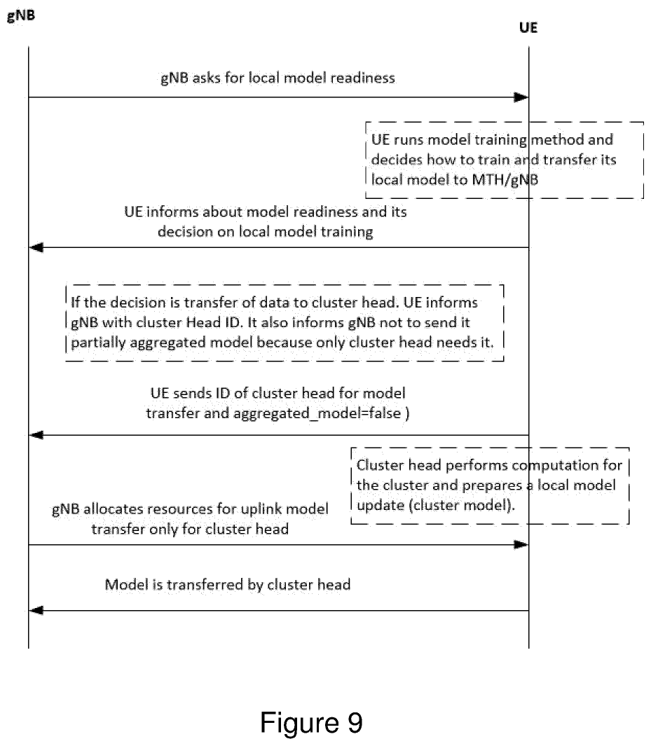

FIG. 9 shows a sequence diagram illustrating an example of a procedure according to at least one exemplifying embodiment. This procedure corresponds to a case in which the DTH/UE decides to perform delegation, especially the first type delegation, and delegates, to the gNB, cluster model computation and cluster model communication to the MTH (in the method/process of FIG. 2).

In the procedure of FIG. 9, the DTH/UE sends an information regarding its decision to the network, i.e. the MTH/gNB. For example, as illustrated, the DTH/UE informs the MTH/gNB about the ID of its cluster head (in order to inform the MTH/gNB that the model, i.e. the cluster model, will be transferred from the DTH/UE representing the cluster head and facilitate the MTH/gNB to provide the partially aggregated global model to the cluster head instead of to the DTH/UE) and the fact that the DTH/UE does not desire or need to receive the partially aggregated global model (e.g. by way of an indication such as aggregated_model=false). This is because the partially aggregated global model is required at the cluster head, but not at the DTH/UE.

Such information provision or signaling between the MTH and the DTHs/UEs can be configured via RRC signaling, and the model data transfer can be performed via RRC and/or SDAP signaling.

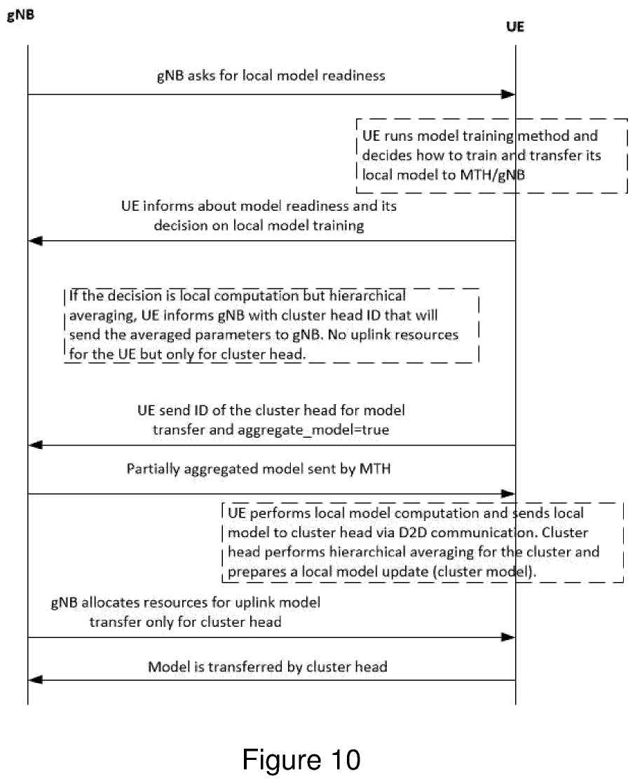

FIG. 10 shows a sequence diagram illustrating an example of a procedure according to at least one exemplifying embodiment. This procedure corresponds to a case in which the DTH/UE decides to perform delegation, especially the second type delegation, and delegates, to the gNB, cluster model parameter averaging and cluster model communication to the MTH (in the method/process of FIG. 2).

In the procedure of FIG. 10, the DTH/UE sends an information regarding its decision to the network, i.e. the MTH/gNB. For example, as illustrated, the DTH/UE informs the MTH/gNB about the ID of its cluster head (in order to inform the MTH/gNB that the model, i.e. the cluster model, will be transferred from the DTH/UE representing the cluster head and facilitate that the MTH/gNB allocates resources for the transfer of the averaged cluster model from the cluster head to the MTH/gNB) and the fact that the DTH/UE desires or needs to receive the partially aggregated global model (e.g. by way of an indication such as aggregated_model=true). This is because the partially aggregated global model is required at the DTH/UE, while the cluster head needs to transfer the averaged cluster model to the MTH/gNB.

Such information provision or signaling between the MTH and the DTHs/UEs can be configured via RRC signaling, and the model data transfer can be performed via RRC and/or SDAP signaling.

FIG. 11 shows a schematic diagram illustrating an example of clustering-based network configuration and operation according to at least one exemplifying embodiment. It is to be noted that FIG. 11 represents an exemplary illustration only such that the number and arrangement of the individual hosts/nodes is not limited to the illustrated scenario.

As shown in FIG. 11, an implementation or use case of a hierarchical configuration, as illustrated in FIG. 1, in a wireless communication system may be such that a gNB-CU, i.e. higher-level/ranking communication control element or function, represents or operates as MTH (corresponding to the CTH of FIG. 1), one or more gNB-DUs, i.e. lower-level/ranking communication control element or function, represent or operate as DTHs (corresponding to the CHs of FIG. 1), and one or more UEs, i.e. communication elements or functions, represent or operate as DTHs (corresponding to the THs of FIG. 1). More generally, any higher-level/ranking communication control element or function may represent or operate as MTH, and any lower-level/ranking communication control element or function may represent or operate as cluster head. For example, the MTH may be realized or implemented by/at any master controller, master gNB, RIC, master training host, gNB-CU, or the like.

In this case, the clustering of the hosts basically corresponds to the cells/coverage of the base stations, namely the gNB-DUs. Namely, DTH/UE1 to DTH/UE3 belong to one cluster, i.e. the cell of gNB-DU1, with gNB-DU1 being the cluster head and DTH/UE1 to DTH/UE3 being the cluster members, and DTH/UE4 to DTH/UE6 belong to another cluster, i.e. the cell of gNB-DU2, with gNB-DU2 being the cluster head and DTH/UE4 to DTH/UE6 being the cluster members.

In the clusters, the DTHs/UEs may communicate with their cluster head via device-to-device (D2D) and/or sidelink communication or via uplink/downlink communication (i.e. network-based communication), and each of the cluster heads may communicate with the gNB-CU via inter-gNB and/or internal communication, as illustrated by the arrows.

In such a network configuration, the methods/processes of FIGS. 2 and 3 may be realized/implemented at the UE (side), the method/process of FIG. 4 may be realized/implemented at the RAN (side), and the method/process of FIG. 5 may be realized/implemented at the RAN (side). For realization or implementation of local model training according to one or more exemplifying embodiments, the network, such as the gNB-CU, should be or even needs to be aware of the UE decision (local training or delegation) and provide required support.

The network configuration of FIG. 11 exemplarily shows application in a 5G NR split-RAN architecture. Here, it could be possible to select gNB-CU as MTH and different gNB-DUs perform as cluster heads. In this case, there is no need to change the cluster head in each round or instance of model collection. Still, all the UEs should have a (strict) trust agreement with the gNB-DU if they want to share their data for joint training. For hierarchical averaging of local updates, there is no need for such (strict) trust agreement.

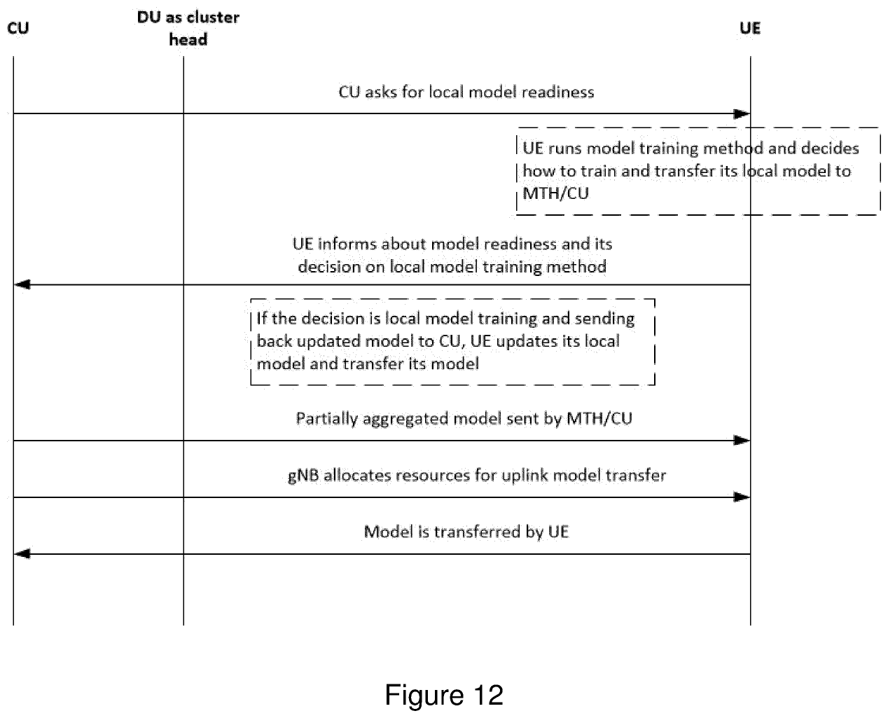

In the following, exemplary procedures are described, which are applicable in/for the clustering-based network configuration of FIG. 11. Namely, FIGS. 12 to 15 show exemplary operation and signaling/communication for the case that the UE acts as DTH, the DU (i.e. the gNB-DU) as cluster head, and the CU (i.e. gNB-CU) acts as MTH.

FIG. 12 shows a sequence diagram illustrating an example of a procedure according to at least one exemplifying embodiment. This procedure corresponds to a case in which the DTH/UE decides to perform local model training and locally performs model training (in the method/process of FIG. 2).

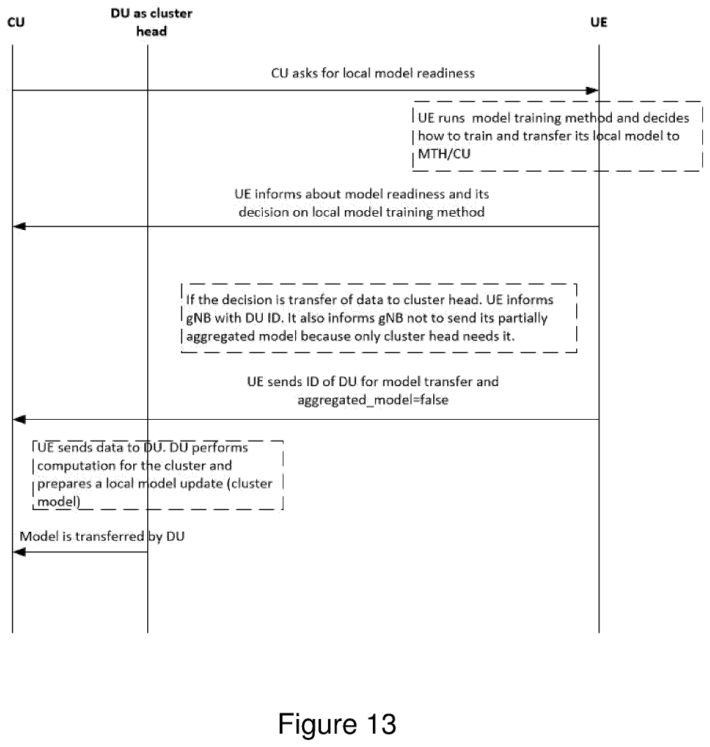

FIG. 13 shows a sequence diagram illustrating an example of a procedure according to at least one exemplifying embodiment. This procedure corresponds to a case in which the DTH/UE decides to perform delegation, especially the first type delegation, and delegates, to the gNB, cluster model computation and cluster model communication to the MTH (in the method/process of FIG. 2).

In the procedure of FIG. 13, the DTH/UE sends an information regarding its decision to the network, i.e. the MTH/gNB-CU. For example, as illustrated, the DTH/UE informs the MTH/gNB-CU about the ID of its cluster head, namely the gNB-DU (in order to inform the MTH/gNB-CU that the model, i.e. the cluster model, will be transferred from the gNB-DU representing the cluster head and facilitate the MTH/gNB-CU to provide the partially aggregated global model to the cluster head instead of to the DTH/UE) and the fact that the DTH/UE does not desire or need to receive the partially aggregated global model (e.g. by way of an indication such as aggregated_model=false). This is because the partially aggregated global model is required at the cluster head, namely the gNB-DU, but not at the DTH/UE.

Accordingly, the DTH/UE sends its local training data to the gNB-DU acting as its cluster head, and the gNB-DU acting as its cluster head generates/computes the local model (as the cluster mode) and transfers it to the MTH/gNB-CU.

Such information provision or signaling between the MTH and the DTHs/UEs can be configured via RRC signaling, and the model data transfer can be performed via RRC and/or SDAP signaling.

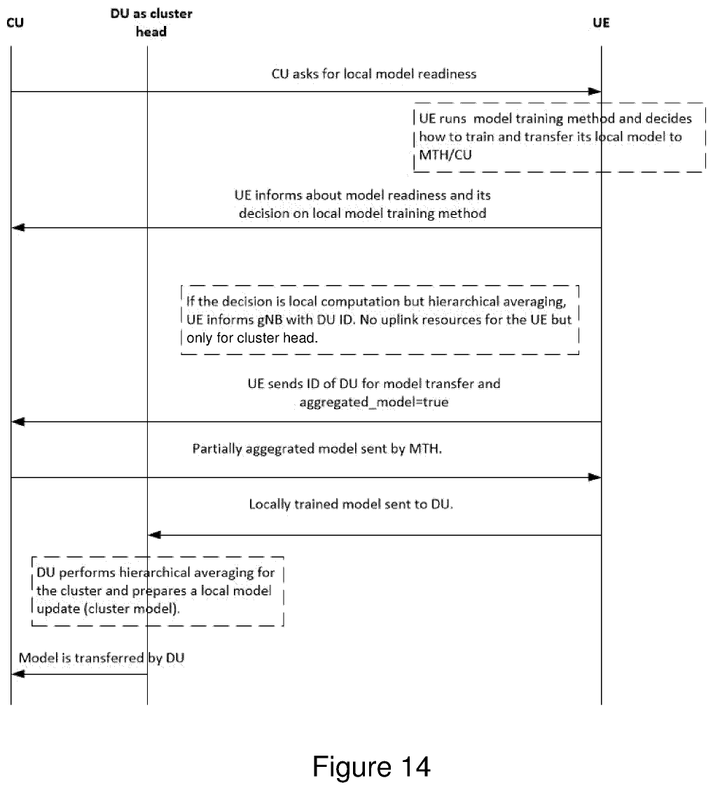

FIG. 14 shows a sequence diagram illustrating an example of a procedure according to at least one exemplifying embodiment. This procedure corresponds to a case in which the DTH/UE decides to perform delegation, especially the second type delegation, and delegates, to the gNB, cluster model parameter averaging and cluster model communication to the MTH (in the method/process of FIG. 2).

In the procedure of FIG. 14, the DTH/UE sends an information regarding its decision to the network, i.e. the MTH/gNB-CU. For example, as illustrated, the DTH/UE informs the MTH/gNB-CU about the ID of its cluster head, namely the gNB-DU (in order to inform the MTH/gNB-CU that the model, i.e. the cluster model, will be transferred from the gNB-DU representing the cluster head and facilitate that the MTH/gNB-CU allocates resources for the transfer of the averaged cluster model from the cluster head to the MTH/gNB-CU) and the fact that the DTH/UE desires or needs to receive the partially aggregated global model (e.g. by way of an indication such as aggregated_model=true). This is because the partially aggregated global model is required at the DTH/UE, while the cluster head needs to transfer the averaged cluster model to the MTH/gNB-CU.

Accordingly, the DTH/UE sends its locally trained model to the gNB-DU acting as its cluster head, and the gNB-DU acting as its cluster head averages the local models of the cluster DTHs/UEs to generate/compute the local model (as the cluster mode) and transfers it to the MTH/gNB-CU.

Such information provision or signaling between the MTH and the DTHs/UEs can be configured via RRC signaling, and the model data transfer can be performed via RRC and/or SDAP signaling.

As is evident from any one of FIGS. 9, 10, 13 and 14, exemplifying embodiments may involve specific signaling aspects, particularly for the case that delegation (i.e. first or second type delegation) is decided by the DTH.

According to various exemplifying embodiments, realization or implementation of cluster-based FL model computation (i.e. the first type delegation) or hierarchical averaging (i.e. the second type delegation) may involve some changes in signaling so as to enable proper operations at the network side (such as in the method/process of FIG. 5), which are different from conventional approaches which assume default local model computation and update. If the MTH already is aware that a DTH or which DTH will not perform local model update, it does not need to send partially aggregated model to those DTHs in case a cluster head performs local model update on augmented data from multiple DTHs.

According to various exemplifying embodiments, various specific signaling/operations may be as follows:
(1) A DTH explicitly informs the MTH whether it performs local model computation or not. If the DTH sends its local data to its cluster head, there is no need to send partially aggregated model to it, thus saving downlink data transmission.
(2) If a DTH performs local model computation but decides to give it to cluster head for hierarchical averaging, the MTH does not need to assign them any uplink model transfer resources, and it does not wait for its model update before starting aggregation of model.

As described above, there are disclosed various exemplifying embodiments for/of clustering-based hierarchical federated learning model training.

According to exemplifying embodiments of this basic aspect or concept, an adaptive approach is presented to allow DTHs use computational power and energy of neighboring nodes, and allow a more computation/communication efficient federated learning model training.

Besides individual effects and advantages described above in certain contexts, the following effects and advantages can be achieved.

A non-uniform distribution of performance, such as computational power, communication power and battery energy, can be exploited to make federated learning model transfer more computationally efficient and the system/network more sustainable, i.e. to achieve increased efficiency in terms of computation, communication and/or energy respects. A use of local updates on data collected by several DTHs can make data more iid and helps faster aggregated model convergence. A use of hierarchical averaging at cluster head level can make model transfer more link-efficient with smaller uplink data transfer.

The problem of model collection from distributed hosts in a federated learning paradigm can be solved in an efficient manner even when all the DTHs do not have enough processing power/energy to train their local models and transmit them back to the MTH within latency constraints imposed by federated learning training in each round or instance of synchronous or asynchronous model collection.

A model training (i.e. update/transfer) scheme can be provided, which takes into account both computation and communication cost as well as computational power and/or energy of the DTHs to complete local model update/transfer in FL without affecting the convergence of the global model.

Hence, the problem of efficient model collection from the DTHs by accounting for their energy state as well as computation power for FL tasks can be solved. As the DTHs may decide to delegate their computation and/or communication task to some other entity located nearby, this can contribute to aggregated/aggregating models without any loss of performance.

Hereinafter, a second basic aspect or concept of enabling/realizing efficient federated-learning model training in a wireless communication system is described. This second basic aspect or concept basically refers to broadcast-based clustering for hierarchical federated learning model training.

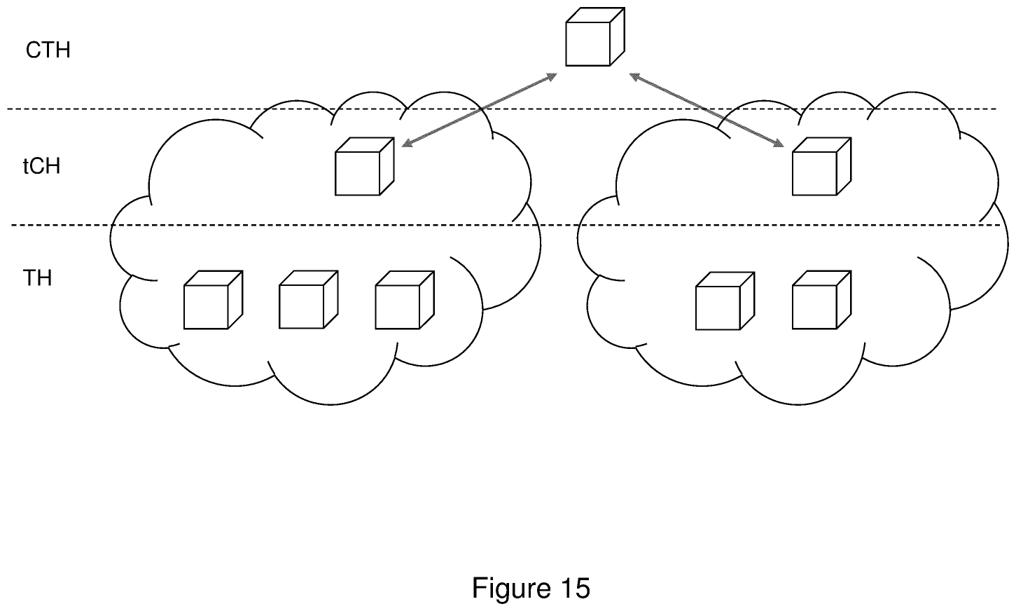

FIG. 15 shows a schematic illustration of a hierarchical configuration of nodes in a federated-learning framework according to at least one exemplifying embodiment. It is to be noted that FIG. 15 represents an exemplary illustration only such that the number and arrangement of the individual hosts/nodes is not limited to the illustrated scenario.

As shown in FIG. 15, a hierarchical configuration is composed of a lower level of one or more federated-learning training hosts referred to as training hosts (TH), an intermediate level of one or more federated-learning training hosts referred to as temporary cluster heads (tCH), and an upper level of a central federated-learning training host referred to as central training host (CTH). It is assumed that a group of federated-learning training hosts can build/establish a cluster, each cluster having one temporary cluster head CH.

Any one of the federated-learning training hosts is hosting a training of a machine-learning model in the federated-learning framework. For example, a local model is respectively learned at/by each TH and possibly each tCH, and a global model is learned at/by the C_{M}. Accordingly, the THs and tCHs may represent Distributed Training Hosts (DTHs), and the CTH may represent a Meta Training Host (MTH).

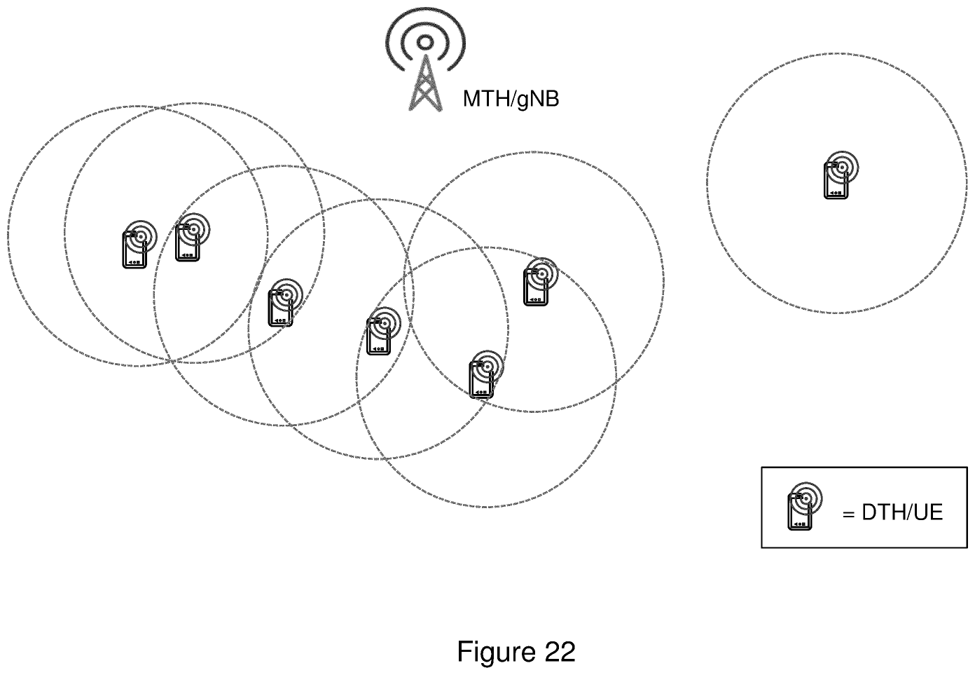

In FIG. 15, a cloud-like shape around a group of federated-learning training hosts schematically illustrates their mutual communication or broadcast range, meaning that the federated-learning training hosts within such range are at least partially communicable with each other (as is illustrated e.g. in FIG. 22). The arrows in FIG. 15 represent communication links between the individual hosts/nodes, showing that each of the tCHs is communicable with the CTH. Although not shown in FIG. 15, there are typically also communication links such that the THs are directly communicable with the CTH (without involving the tCH), respectively. The TH-tCH communication links may be device-to-device (D2D) and/or sidelink communication links, i.e. enabling a one-to-one communication, irrespective of its implementation. The tCH-CTH communication links may be typical radio network (RAN) links.

It is or may be assumed that the hosts/nodes in a cluster (to be built/established) trust each other and are allowed to share data. As noted above, this can be assumed to be particularly true for private networks in 5G/NR where many nodes under the same personal network can trust each other and share data. Also, it is or may be assumed that the hosts/nodes in a cluster (to be built/established) can identify each other, which may for example be achievable by any known authentication and authorization procedure, with or without network involvement, or the like.

For potential implementations of the thus illustrated hierarchical configuration, reference is made to the description of FIGS. 7 and 11 above, which are (at least in principle) equally applicable here as well (except for the D2D communication links between the hosts/nodes within one cluster which is to be built/established).

According to at least one exemplifying embodiment, an implementation or use case of a hierarchical configuration, as illustrated in FIG. 15, in a wireless communication system may be such that a gNB, i.e. communication control element or function, represents or operates as MTH (corresponding to the CTH of FIG. 15), one or more UEs, i.e. communication elements or functions, represent or operate as DTHs (corresponding to the tCHs of FIG. 15), and one or more UEs, i.e. communication elements or functions, represent or operate as DTHs (corresponding to the THs of FIG. 15).

In such a case, the device (sidelink) broadcast communication between the hosts/edges of a cluster (to be built/established) is such that it enables communication between the hosts/edges without involving any higher-level/ranking entities, such as a CTH/MTH like a gNB.

In such a case, the device (sidelink) broadcast communication between the hosts/edges of a cluster (to be built/established) is assumed to be supported by the UEs. This can be available following 3GPP 4G/5G/NR procedures, e.g. used for ProSe discovery and communications over PCS, or any non-3GPP technologies such as WiFi (Direct), Bluetooth (e.g. Bluetooth) 5, Zigbee, or the like. The communication/radio technology of the device (sidelink) broadcast communication may be different from the communication/radio technology of an uplink communication between tCH and CTH/MTH like a gNB.

According to at least one exemplifying embodiment, an implementation or use case of a hierarchical configuration, as illustrated in FIG. 15, in a wireless communication system may be such that any higher-level/ranking communication control element or function may represent or operate as MTH (corresponding to the CTH of FIG. 15), and any lower-level/ranking communication or communication control element or function may represent or operate as federated-learning training host, namely as temporary cluster head and training host (corresponding to the tCHs and the THS of FIG. 15). For example, the MTH may be realized or implemented by/at any master controller, master gNB, RIC, master training host, gNB-CU, or the like, and the temporary cluster head and training host may be realized or implemented by a communication control element or function such as a gNB.

In such a case, the device (sidelink) broadcast communication between the hosts/edges of a cluster (to be built/established) is such that it enables communication between the hosts/edges without involving any higher-level/ranking entities, such as a CTH/MTH like a gNB-CU.

In such a case, the device (sidelink) broadcast communication between the hosts/edges of a cluster (to be built/established) is assumed to be supported by the communication control elements or functions, such as the gNB entities. This can be available following 3GPP 4G/5G/NR procedures, e.g. in that the broadcast links are implemented either with inter-gNB communication interfaces, such as Xn, or via the eMBMS-like broadcast. The communication/radio technology of the device (sidelink) broadcast communication may be different from the communication/radio technology of an uplink communication between tCH and CTH/MTH like a gNB-CU.

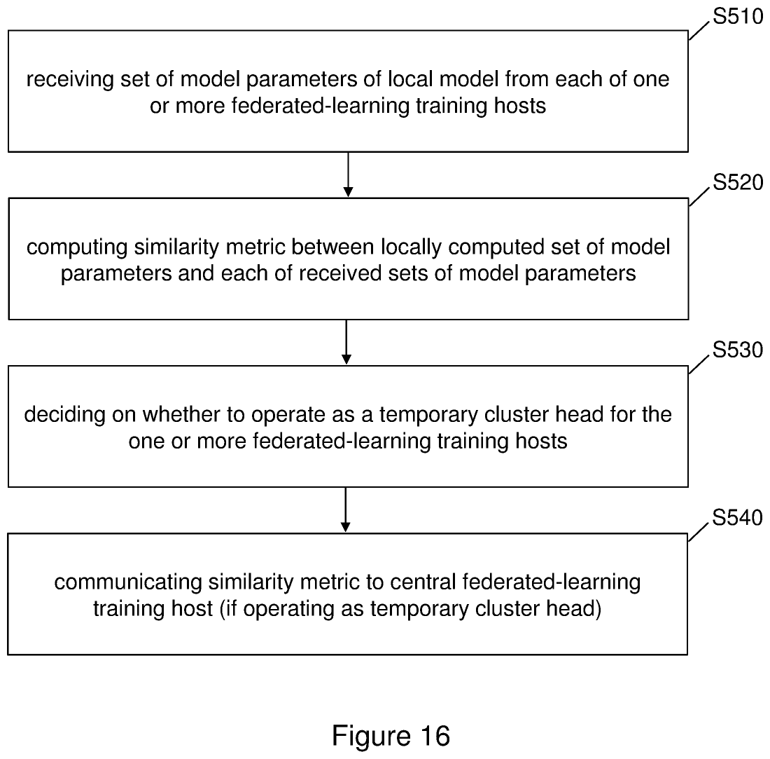

FIG. 16 shows a flowchart illustrating an example of a method/process according to at least one exemplifying embodiment. The method/process of FIG. 16 is a method/process of (or, stated in other words, operable or for use in/by) a communication entity in a wireless communication system, which is configured to act as a federated-learning training host configured for local model training, such as a DTH or a TH/tCH of FIG. 15.

As shown in FIG. 16, the method/process comprises an operation (S510) of receiving a set of model parameters of a local model from each of one or more federated-learning training hosts (corresponding to the THs of FIG. 15), an operation (S520) of computing a similarity metric between a locally computed set of model parameters of a local model and each of the received sets of model parameters, an operation (S530) of deciding on whether to operate as a temporary cluster head for the one or more federated-learning training hosts, and an operation (S540) of communicating the computed similarity metric to a central federated-learning training host configured for global model training when it is decided to operate as the temporary cluster head.

According to at least one exemplifying embodiment, the method/process may further comprise determining, for each of the one or more federated-learning training hosts, whether its individual similarity metric is larger than a predefined similarity threshold. Then, an identification of each federated-learning training host, for which it is determined that its individual similarity metric is larger than the predefined similarity threshold, may be communicated together with the similarity metric. In this regard, the individual similarity metric of each federated-learning training host, for which it is determined that its individual similarity metric is larger than the predefined similarity threshold, may be communicated together with the similarity metric.

According to at least one exemplifying embodiment, the method/process may further comprise determining whether sets of model parameters, which result in an individual similarity metric larger than a predefined number threshold, from at least a predefined number of federated-learning training hosts is received. Then, it may be decided to operate as the temporary cluster head when it is determined that the received number of sets of model parameters is larger than the predefined number threshold.

According to at least one exemplifying embodiment, the method/process may further comprise determining whether available performance, including one or more of computational power, communication power or energy, is larger than a predefined performance threshold. Then, it may be decided to operate as the temporary cluster head when it is determined that the available performance is larger than the predefined performance threshold.

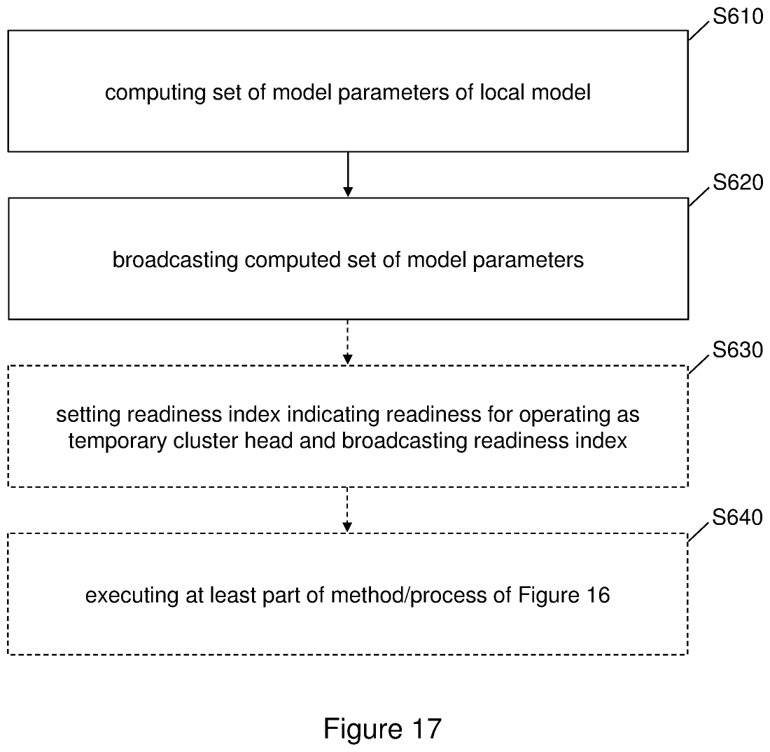

FIG. 17 shows a flowchart illustrating an example of a method/process according to at least one exemplifying embodiment. The method/process of FIG. 17 is a method/process of (or, stated in other words, operable or for use in/by) a communication entity in a wireless communication system, which is configured to act as a federated-learning training host configured for local model training, such as a DTH or a TH of FIG. 15.

As shown in FIG. 17, the method/process comprises an operation (S610) of computing a set of model parameters of a local model, and an operation (S620) of broadcasting the computed set of model parameters. The broadcasting is performed by way of a device (sidelink) broadcast communication, i.e. a D2D broadcast.

Optionally, as indicated by dashed lines, the method/process may also comprise, either before or after the computing operation (S610) and/or the broadcasting operation (S620), an operation (S630) of setting a readiness index indicating a readiness for operating as temporary cluster head and broadcasting the set readiness index.

Optionally, as indicated by dashed lines, the method/process may also comprise, either before or after the computing operation (S610) and/or the broadcasting operation (S620), an operation (S640) of executing at least part of the method/process of FIG. 16 as described above. Namely, the communication entity performing the method/process may also decide on whether to operate as a temporary cluster head.

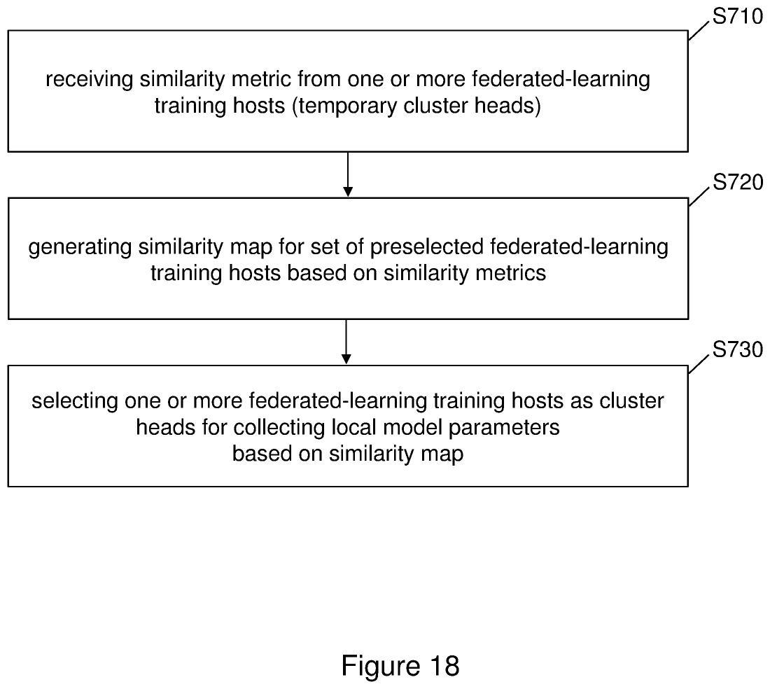

FIG. 18 shows a flowchart illustrating an example of a method/process according to at least one exemplifying embodiment. The method/process of FIG. 18 is a method/process of (or, stated in other words, operable or for use in/by) a communication entity in a wireless communication system, which is configured to act as a central federated-learning training host configured for global model training for a set of preselected federated-learning training hosts each being configured for local model training, such as a MTH or CTH of FIG. 15.

As shown in FIG. 18, the method/process comprises an operation (S710) of receiving a similarity metric (indicating a similarity between local model parameters of a number of federated-learning training hosts) from one or more federated-learning training hosts representing temporary cluster heads out of the set of preselected federated-learning training hosts, an operation (S720) of generating a similarity map for the set of preselected federated-learning training hosts based on the received one or more similarity metrics, and an operation (S730) of selecting one or more federated-learning training hosts as cluster heads for collecting local model parameters based on the generated similarity map.

According to at least one exemplifying embodiment, each similarity metric may comprise at least one of: a set of local model parameters which are locally computed at the federated-learning training host, from which the similarity metric is received, an identification of one or more federated-learning training hosts having local model parameters with high similarity to the local model parameters which are locally computed at the federated-learning training host, from which the similarity metric is received, or an individual similarity metric of one or more federated-learning training hosts having local model parameters with high similarity to the local model parameters which are locally computed at the federated-learning training host, from which the similarity metric is received.

According to at least one exemplifying embodiment, the method may further comprise one or more of: triggering collection of local model parameters from the one or more federated-learning training hosts which are selected as cluster heads, aggregating a global model based on collected local model parameters and the generated similarity map, or providing an at least partially aggregated model to the one or more federated-learning training hosts which are selected as cluster heads.

According to at least one exemplifying embodiment, the method may further comprise configuring the set of preselected federated-learning training hosts for at least one of model training or model collection.

In the following, exemplarily details of a conceivable realization or implementation of the above methods/processes are described for illustrative purposes.

According to at least one exemplifying embodiment, (all of) the DTHs such as the UEs (which participate or are preselected to participate in such clustering approach) broadcast a selected set of model parameter of their respective local models (such as e.g. weights for selected layers), and make them thus available to other DTHs such as UEs within their broadcast communication range. All of the DTHs such as the UEs which receive such broadcast transmissions compute a ‘similarity metric’ between each of the received models, i.e. each set of the received model parameters, and their own model, i.e. their locally computed model parameters. When the similarity metric is above a certain threshold, then the DTH such as the UE can decide to operate as ‘temporary cluster head’ (e.g. for the DTHs such as the UEs, from which it received their models. Then, the DTH such as the UE informs the MTH accordingly, e.g. by sending its own local model parameters along with the other UEs' IDs which have a high similarity metric. In this way, the MTH can build a ‘similarity map’ of the DTH models, and can avoid asking for model parameters from all the DTHs such as the UEs. When a DTH such as a UE signals the model parameters to the MTH, it can also inform its neighbor DTH or DTHs such as its neighbor UE or UEs about its decision, hence other DTHs such as UEs can avoid transmission (of their own local model parameters and/or a corresponding decision) to the MTH. Rather, any neighbor DTH receiving such information can assume the sending/issuing UE as (its) ‘temporary cluster head’.

Accordingly, there is provided a self-organized adaptive method to allow DTHs use computational/communication power and energy of the neighboring node or nodes and allow a more communication-efficient federated-learning model training. Hence, any DTH performs a self-election of being a temporary cluster head, and in the following any temporary cluster head (or, stated in other terms, temporary cluster-head DTH/UE) is a temporary self-elected cluster head.

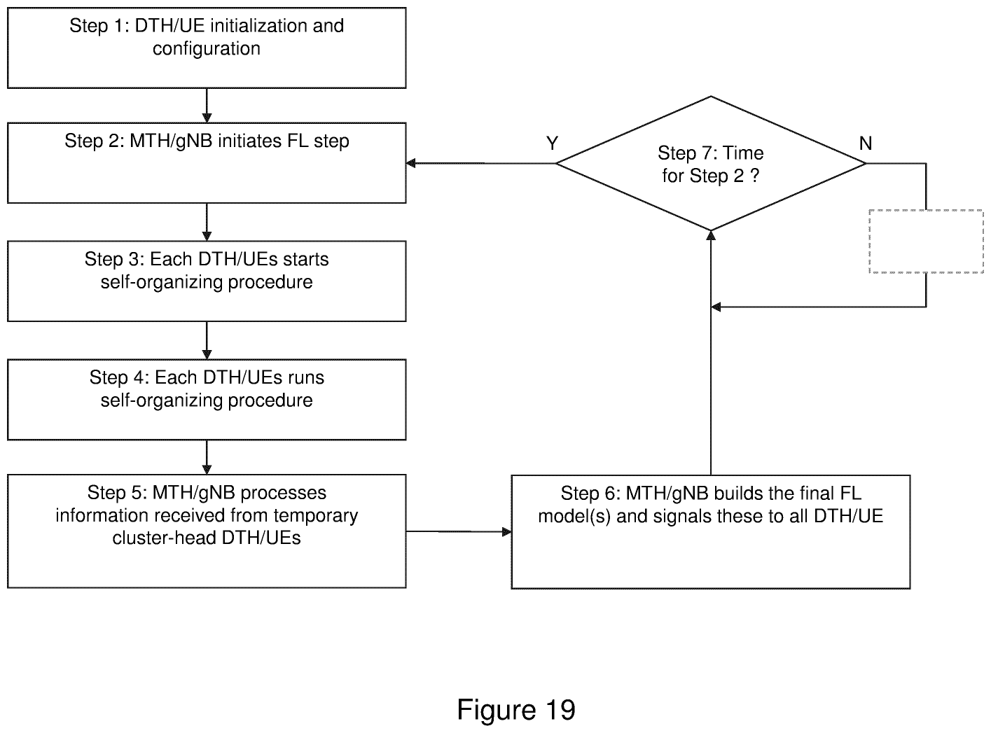

FIG. 19 shows a flowchart illustrating an example of a method/process according to at least one exemplifying embodiment. The method/process of FIG. 19 is an overall method/process which is illustrated from a system perspective, i.e. including (main) aspects and operations of each of the involved entities, namely the MTH exemplarily assumed to be a gNB and DTHs exemplarily assumed to be UEs, wherein one of the DTHs/UEs (i.e. the subject DTH/UE) may decide to operate as temporary cluster head.

In a step 1 of FIG. 19, the DTH/UE initialization and configuration is performed or effected. In this regard, the MTH/gNB may configure a target set of DTHs/UEs to be used in the federated-learning (FL) procedure. Such preselection of participating DTHs/UEs may be based on e.g. a given geographical area, network range/domain, or the like, and/or their mobility, traffic, etc. In this step, all of the selected DTH/UEs are informed in terms of initialization and configuration accordingly. For example, they may be informed about the type of (local or global) model to be trained and its main parameters. This step may also include the necessary signaling and/or configuration which enables the selected DTHs/UEs to trust each other, i.e. to enable a clustering of/among them. Optionally, in this step, the MTH/gNB may also be informed on the potential computation, communication and/or energy capabilities (or limitations) of certain DTHs/UEs.

In a step 2 of FIG. 19, the MTH/gNB initiates a federated-learning (FL) step. In this regard, the MTH/gNB may execute this step periodically (in the context of synchronous model collection or aggregation) or event-based (in the context of asynchronous model collection or aggregation) to be able to collect, i.e. accumulate, the model parameters for the final ML model. In this step, the MTH/gNB may inform the DTHs/UEs which FL model collection procedure shall be used (e.g. parameters, timers, etc.) which will then be applied in subsequent steps. This information may also be already available at the DTHs/UEs from the preceding step 1, and here the MTH/gNB may only select a configuration. Alternatively, the full configuration may be provided to the DTHs/UEs. The signaling for this step may be UE-specific via RRC/DCI or may be on cell-level via multicast/broadcast.

In a step 3 of FIG. 19, each of the (preselected) DTHs/UEs starts the self-organizing procedure. Upon a corresponding trigger, such as e.g. upon receiving a signaling from the MTH/gNB in step 2, any DTH/UE may start building its local model or models and (gradually/periodically) broadcast its computed model parameters (such as weights for selected layers). In this regard, the device broadcast procedures (of layers L1 to L3) to be followed may be assumed to be previously configured, such as in step 1. In this step, any DTH/UE may also set/determine and broadcast a priority indication, which indicates (to the other DTHs/UEs) its readiness/willingness (such as its readiness/willingness factor) to become temporary cluster head. By way of such priority indication, the self-organized temporary cluster head selection may be made more effective by avoiding establishment of too many simultaneous temporary cluster head DTHs/UEs. Such priority indication may be pre-configurable (i.e. configured in preceding steps 1 and/or 2), may be randomly chosen within preconfigured limits (i.e. configured in preceding steps 1 and/or 2) and/or may depend on computation and/or communication costs for a federated-learning training task, such as any one or more of above-mentioned costs like C_{M}, C_{DT} and C_{N}, which may be estimated at/by any DTH/UE.

An exemplary network situation in/of step 3 is illustrated in FIG. 22.

In a step 4 of FIG. 19, each of the (preselected) DTHs/UEs runs the self-organizing procedure. In this regard, any DTH/UEs may collect information received via the device broadcast channel, any may use the thus collected information in terms of temporary cluster head selection.

This step may comprise one more of sub-steps as described below.

In a sub-step, herein referred to as step 4a, any DTH/UE may compute a ‘similarity metric’ between the received model parameters, i.e. the local model parameters from its neighboring DTHs/UEs, and its own local model parameters, i.e. the locally computed model parameters, for each received set of model parameters.

In a sub-step, herein referred to as step 4b, the ID of the transmitting DTH/UE may be stored when the computed similarity metric (for/of this DTH/UE) is above a preconfigured threshold.

In a sub-step, herein referred to as step 4c, any DTH/UE, which has computed a similarity metric while satisfying certain conditions, such as collection of model parameters with sufficiently high similarity metrics from a preconfigured number of neighbor DTHs/UEs, may communicate/signal, to the MTH/gNB, its model parameters along with the IDs of the DTHs/UEs which have been determined to have a similarity metric, such as e.g. a sufficiently high similarity metric. Thereby, the DTH/UE communicates its decision of operating as temporary cluster head, which it has taken e.g. based on the received and own local model parameters, to the MTH/gNB.

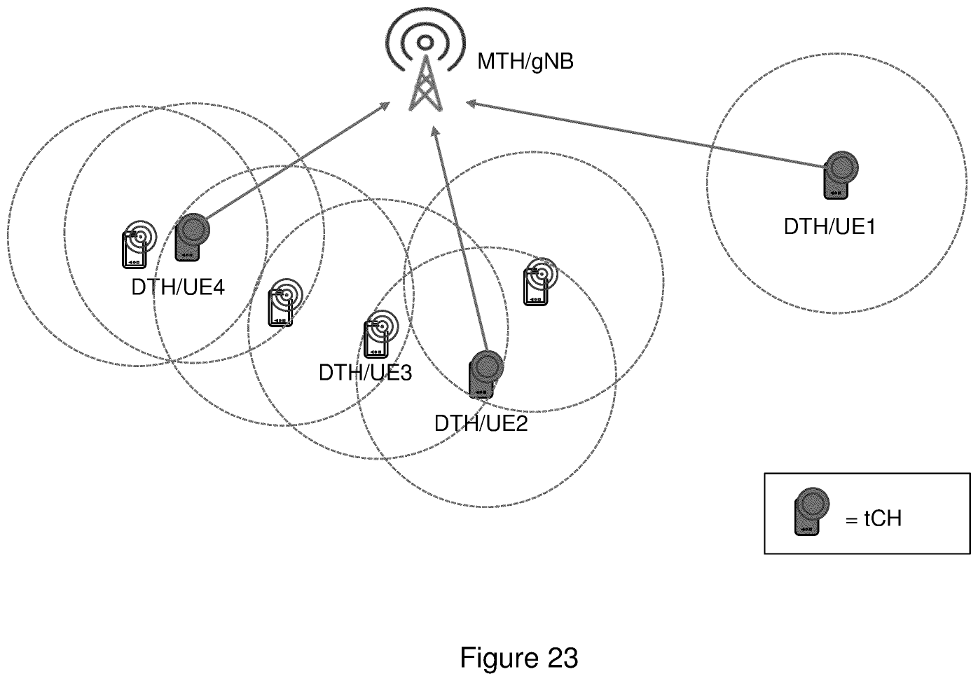

An exemplary network situation in/of step 4c is illustrated in FIG. 23.

In a sub-step, herein referred to as step 4d, any DTH/UE, which has executed step 4c, may then broadcast an indication of this action, i.e. its decision of operating as temporary cluster head, to the neighbor DTH/UEs. Thereby, for any DTH/UE receiving such indication, it is assumed to be a temporary cluster head for a certain time period (which is configurable in preceding steps 1 and/or 2).

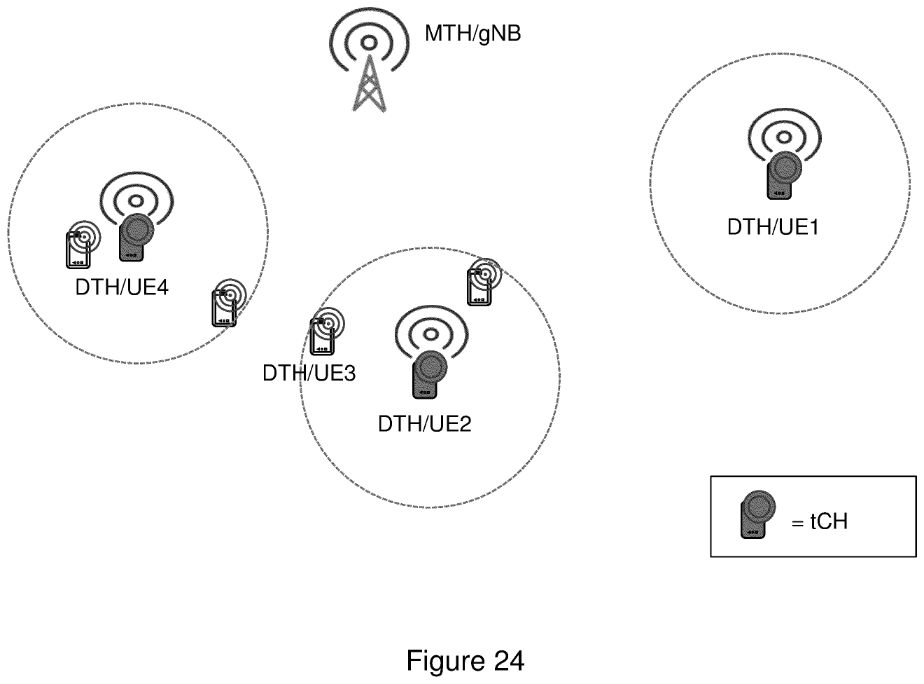

An exemplary network situation in/of step 4d is illustrated in FIG. 24.

In a sub-step, herein referred to as step 4e, any DTH/UE may estimate its performance, such as its computation power, communication power and/or energy (budget), and determine whether its performance is above a preconfigured threshold (i.e. whether it has sufficient performance in order to (decide to) operate as temporary cluster head). If the DTH/UE decides that it has insufficient performance, it may not execute step 4c (and step 4d), meaning that it may not decide to operate as temporary cluster head. Thereby, any DTH/UE with insufficient performance may be automatically excluded from the set of temporary cluster heads.

Accordingly, depending on its performance, each DTH/UE may always perform steps 1 to 3, 4a and 4b, but may perform step 4c (and step 4d) only if there is sufficient performance. In the decision of whether or not there is sufficient performance, any one or more of above-mentioned costs like C_{M}, C_{DT} and C_{N}, which may be estimated at/by any DTH/UE, and/or any one of above-mentioned conditions (i.e. inequalities) may be utilized.

In a sub-step, herein referred to as step 4f, any DTH/UEs, which has not received any broadcast transmissions from other DTHs/UEs, may assume that they it is located in a separate cluster, and may decide whether or not to execute step 4c, e.g. depending on its performance, such as its computation power, communication power and/or energy (budget).

In a sub-step, herein referred to as step 4g, any DTH/UE may use the priority indication signaling as described above in step 3 in its decision of operating as temporary cluster head or not. Thereby, it may be avoided that too many simultaneous temporary cluster-head DTHs/UEs are established.

In a step 5 of FIG. 19, the MTH/gNB processes the information received from the temporary cluster-head DTH/UEs. In this regard, the MTH/gNB may collect the information signaled in step 4 by the temporary cluster heads (in its set or range of (preselected) DTHs/UEs) and build a ‘similarity map’ for all the DTHs/UEs preselected in preceding steps 1 and/or 2.

In a sub-step, herein referred to as step 5a, the MTH/gNB may decide, using the built similarity map on the selection of the final cluster heads or, stated in other terms, the final cluster-head DTHs/UEs, and provide necessary signaling (including e.g. necessary information, configuration, or the like) to these DTHs/UEs.

In a sub-step, herein referred to as step 5b, the MTH/gNB may trigger the collection of further model parameters, i.e. further local model updates (which may potentially include more details than used/provided in preceding steps 3 and/or 4), from its selected final cluster-head DTHs/UEs.

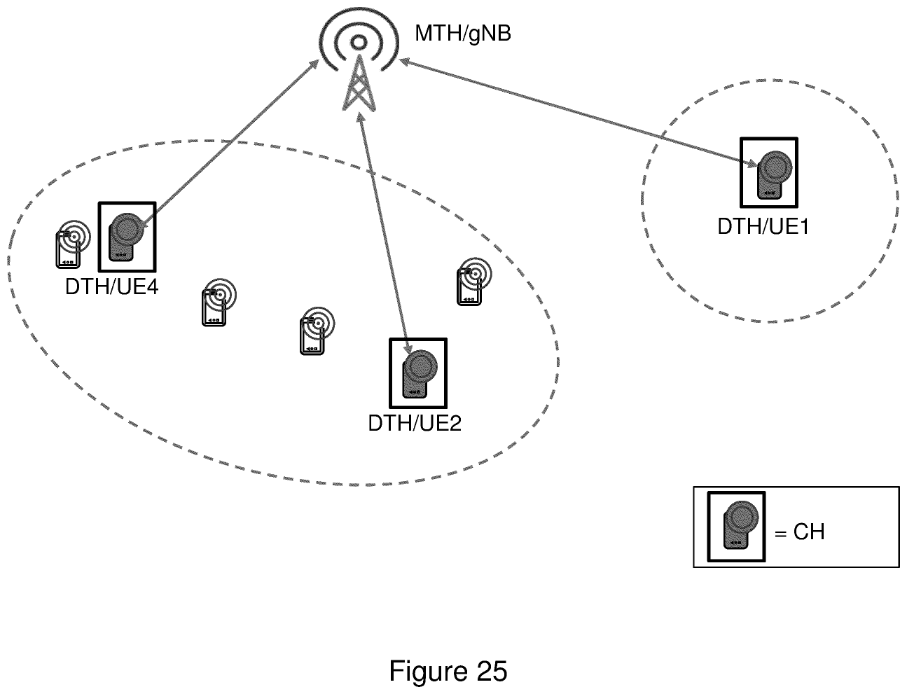

An exemplary network situation in/of step 5 is illustrated in FIG. 25. In this example, DTH/UE1, DTH/UE2 and DTH/UE4 are all determined as cluster heads. On the one hand, DTH/UE2 and DTH/UE4 are cluster heads for the respective UEs (which are in their common/combined range, while not all of them are in the range of any one of DTH/UE2 or DTH/UE4) and receive the same aggregated model based on the similarity map. On the other hand, DTH/UE1 is a cluster head (for its own) and receives another aggregated model based on the similarity map, which can be different from the model received by DTH/UE2 and DTH/UE4.

In a step 6 of FIG. 19, the MTH/gNB builds the final FL model(s) and communicates/signals these to (all of) the DTHs/UEs preselected in preceding steps 1 and/or 2). Namely, the MTH/gNB may aggregate a global model based on the collected local model parameters and the generated similarity map. And the MTH/gNB may provide an at least partially aggregated (global) model, potentially via the selected final cluster heads, to (all of) the DTHs/UEs.

In a step 7 of FIG. 19, the MTH/gNB triggers (repetition/iteration of) step 2 (and subsequent steps) as federated-learning typically requires several iterations. Such repetition/iteration may be triggered either periodically (in the context of synchronous model collection or aggregation) or event-based (in the context of asynchronous model collection or aggregation), such as based on radio measurement and/or radio or non-radio (location, etc.) events received form the DTHs/UEs.

The empty box shown in FIG. 19 illustrates any mechanism for realizing a periodicity of running the FL algorithm, such as e.g. a mechanism which is capable of determining if and when the FL model needs to be retrained.

As indicated above (for/in step 5 of FIG. 19), the MTH/gNB may compute a similarity map for a (preselected) set of DTHs/UEs based on similarity metrics received from temporary cluster heads. For such similarity map computation, some further illustrative explanations are given below.

According to at least one exemplifying embodiment, the MTH/gNB computes a similarity map for the model parameters it has received from the temporary cluster-head DTHs/UEs. The similarity metrics received from the temporary cluster-heads DTHs/UEs may, in combination with additional gNB information, form an information vector, one for each DTH/UE (as e.g. preselected in steps 1 and/or 2 of FIG. 19). These information vectors may be numerically processed to check how clustered they are (e.g. using traditional clustering methods). The outcome of this clustering may be referred to as a similarity map.

The additional gNB information can be radio or non-radio information which is locally available at the MTH/gNB for the DTHs/UEs (as e.g. preselected in steps 1 and/or 2 of FIG. 19).

Non-limiting examples for additional UE-related radio information which can be used involve one or more of the following:
gNB NR beam ID serving the UE: indicates a rough spatial location of the UE
UE mobility state: indicates how fast the radio conditions are likely to change
UE MIMO/beam capabilities: indicate how much the UE can potentially adapt to changing radio conditions, thus roughly implying how much training data it needs to collect (or at which time training data needs to be collected) for the FL model
UE radio broadcast range: indicates (roughly) the range within which a potential cluster head can collect model parameters from other UEs; can be used (only) in combination with some type of UE location information
UE historical FL model accuracy: indicates how much the UE can be trusted to provide good data for the final FL model; this can be quantified with both radio (e.g. success rate and/or outcome of RRM procedure based on the FL model) and non-radio parameters (e.g. FL model parameters and accuracy tests)

Non-limiting examples for additional UE-related non-radio information which can be used involve one or more of the following:
UE location (GNSS- or network-based), including potentially movement vector/acceleration: indicates the likelihood of experiencing similar radio conditions with UEs nearby, and/or can be used in conjunction with pre-calculated service coverage maps, etc.
UE performance (e.g. computation power, communication power and/or energy (budget)) limits: this information can come from step 1 and/or step 2 of FIG. 19, or can be estimated based on historical data from execution of one or more of preceding steps 2 to 5 of FIG. 19
UE historical FL model accuracy: indicates how much the UE can be trusted to provide good data for the final FL model, e.g. quantified in the FL model parameters and accuracy tests metrics are used According to at least one exemplifying embodiment, the similarity metric can adopt various forms.

As indicated above, the similarity metric (which is communicated/signaled from a DTH/UE to the MTH/UE comprises the DTH/UE's own local model (local model parameters) and UE IDs (of UEs being involved in the similarity metric computation, or at least UEs with sufficiently high similarity of their models or model parameters). In addition, the similarity metric may also comprise an indication of the similarity of the models or model parameters of the individual UEs, namely the UEs being involved in the similarity metric computation or at least the UEs with sufficiently high similarity of their models or model parameters.

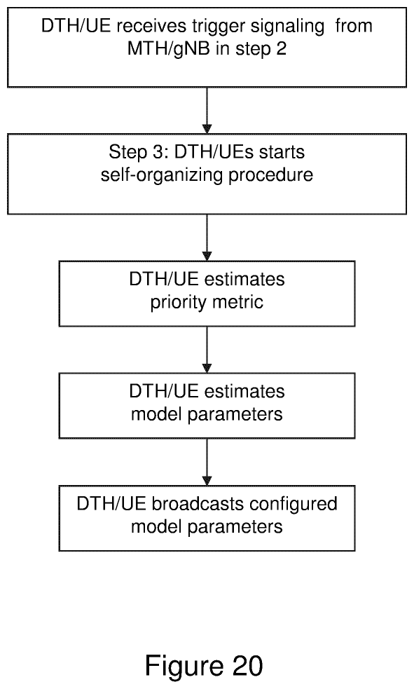

FIG. 20 shows a flowchart illustrating an example of a method/process according to at least one exemplifying embodiment. The method/process of FIG. 20 is an example of details of step 3 of FIG. 19.

As shown in FIG. 20, the DTH/UE, when/in starting the self-organizing procedure, may estimate (i.e. set or determine) its priority metric (i.e. the previously mentioned priority indication), estimate its local model parameters, and broadcast the configured (i.e. computed) local model parameters. As indicated above, the estimation of the priority metric may be optional, and the priority metric may be broadcast and/or used in the DTH/UE's decision on whether or not to operate as temporary cluster head.

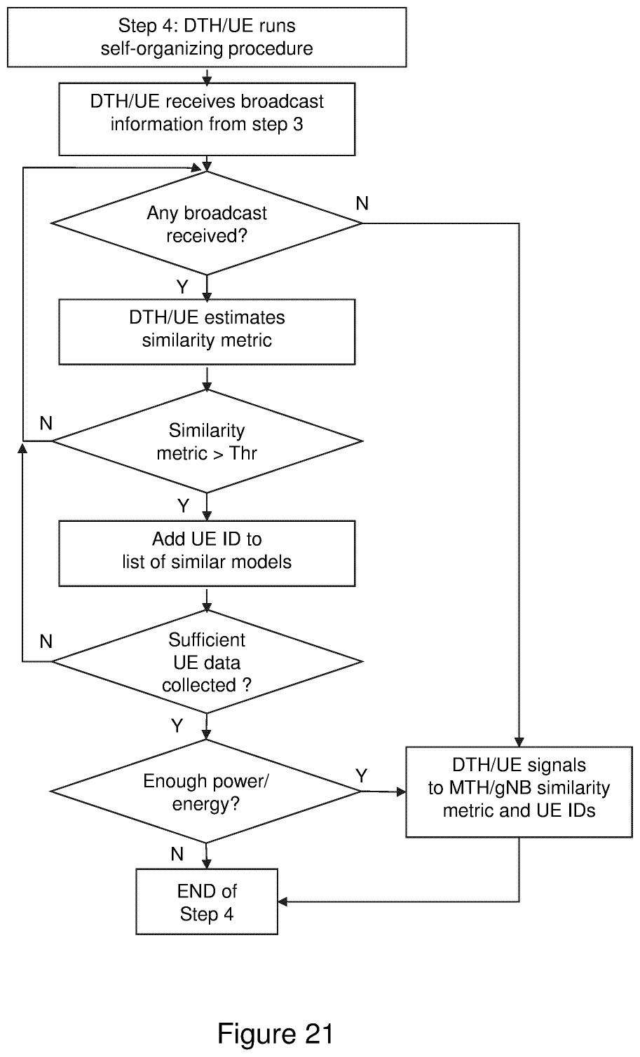

FIG. 21 shows a flowchart illustrating an example of a method/process according to at least one exemplifying embodiment. The method/process of FIG. 21 is an example of details of step 4 of FIG. 19.

As shown in FIG. 21, the DTH/UE, when/in starting the self-organizing procedure, receives broadcasts information, i.e. broadcasted local model information from one or more other DTHs/UEs. When no broadcast is received, the DTH/UE recognizes that it builds its own cluster, and it may inform the MTH/gNB accordingly, e.g. by communicating a corresponding similarity metric (e.g. with no or negative contents). Upon receiving a broadcast, the DTH/UE estimates the similarity metric and determines whether the computed similarity metric is above a predefined threshold (Thr). If not, no further action may taken for this broadcast, If so, the UE ID of this broadcast may be added to a similarity list, i.e. a list of similar models. Optionally, the DTH/UE may determined whether a sufficient amount of UE data is collected, such as e.g. broadcasts (with a sufficiently high similarity metric from three or more other DTHs/UEs). If not, the processing returns to receiving a further broadcast. If so, like in the case when no such sufficiency determination is made, the DTH/UE determines its performance or capability or suitability for operating as temporary cluster head. For example, the performance may include one or more of computational power, communication power or energy, which is simply denoted by “power/energy” in FIG. 21. If there is not enough performance, i.e. the DTH/UE decides to not operate as temporary cluster head, the processing of step 4 is (preliminarily) ended. If there is enough performance, i.e. the DTH/UE decides to operate as temporary cluster head, the DTH/UE communicates the similarity metric to the MTH/gNB, thus informing the MTH/gNB of its decision to operate as temporary cluster head. As indicated above, in this regard, the DTH/UE may signal its own local model parameters (in accordance with the selected/configured model or parameter set) and the IDs of DTH/UEs with similar model parameters.

For further details, reference is made to the description of step 4 above.

Hereinafter, an example of a procedure of broadcast-based clustering for hierarchical FL model training (in line with the above methods/processes) is explained with reference to FIGS. 22 to 25. It is to be noted that FIGS. 22 to 25 represent an exemplary illustration only such that the number and arrangement of the individual hosts/nodes is not limited to the illustrated scenario.

In such a network configuration, the methods/processes of FIGS. 16 and 17 as well as FIG. 21 may be realized/implemented at the UE (side), and the method/process of FIG. 18 may be realized/implemented at the RAN (side), while the method/process of FIG. 19 may be realized/implemented by a cooperation or collaboration of the UE (side) and the RAN (side). For realization or implementation of local model training according to one or more exemplifying embodiments, the network, such as the gNB, should be or even needs to be aware of the UE decision (non-/operation as temporary cluster head) and provide required support.

FIG. 22 shows a schematic diagram illustrating an example of network configuration and operation in a first stage of a procedure according to at least one exemplifying embodiment.

As shown in FIG. 22, an exemplary network situation is assumed, in which seven DTH/UEs represent FL training hosts and a MTH/gNB represents a central FL training host. The circles indicate the broadcast transmission range of each device (for simplicity, equal broadcast transmission ranges are assumed for all DTHs/UEs). Not all of the devices have to be in-range for the broadcast transmissions of other devices, such as e.g. the device on the right hand side (which will subsequently be referred to as DTH/UE1).

In the thus illustrated first stage, the devices broadcast their local model parameters in their depicted broadcast transmission ranges, respectively. This basically corresponds to the operation/functionality of step 3 as described above.

FIG. 23 shows a schematic diagram illustrating an example of network configuration and operation in a second stage of a procedure according to at least one exemplifying embodiment.

As shown in FIG. 23, three devices are assumed to device to operate as temporary cluster heads and inform the MTH/gNB accordingly, namely DTH/UE1, DTH/UE2 and DTH/UE4.

Here, it is assumed that DTH/UE2, DTH/UE3 and DTH/UE4 receive sufficient broadcast information (in this simple example case, from at least 2 other DTHs/UEs) and determine a high similarity metric with their own model. Further, it is assumed that DTH/UE2 and DTH/UE4 decide to operate as temporary cluster head (as they have a sufficient performance, i.e. sufficient computation, communication and/or energy budget), while DTH/UE3 does not have a sufficient performance and thus decides to not operate as temporary cluster head. Still further, it is assumed that DTH/UE #1 does not receive any broadcast transmission, thus automatically assuming that it represents a separate cluster, and signals its (availability for an) operation as temporary cluster head to the MTH/gNB.

In the thus illustrated second stage, the devices having decided to operate as temporary cluster head signal this decision (i.e. corresponding information) to the MTH/gNB. This basically corresponds to the operation/functionality of step 4c as described above.

FIG. 24 shows a schematic diagram illustrating an example of network configuration and operation in a third stage of a procedure according to at least one exemplifying embodiment.

As shown in FIG. 24, the devices operating as temporary cluster heads, i.e. DTH/UE1, DTH/UE2 and DTH4 broadcast an indication of their decision to their neighboring DTHs/UEs, i.e. within their broadcast transmission range.

In the thus illustrated third stage, the devices having decided to operate as temporary cluster head broadcast this decision (i.e. a corresponding indication). This basically corresponds to the operation/functionality of step 4d as described above.

FIG. 25 shows a schematic diagram illustrating an example of network configuration and operation in a fourth stage of a procedure according to at least one exemplifying embodiment.

As shown in FIG. 25, it is assumed that the MTH/gNB has computed the similarity map and decided to select DTH/UE1 as well as DTH/UE2 and DTH/UE4 as final cluster heads based on the similarity map. More specifically, the MTH/gNB has decided to combine DTH/UE2 and DTH/UE4 in the same cluster, while keeping separate DTH/UE #1. As described above, this means that the MTH/gNB indicates/provides the same aggregated (FL) model to DTH/UE2 and DTH/UE4, which may be the same as or different from the aggregated (FL) model being indicated/provided to DTH/UE1. Further, there are communication links between the MTH/gNB and any one of the selected final cluster heads, which is used for communication of information, configuration, etc. (including the final cluster-head decision, partially aggregated model information, etc.) from the MTH/gNB to the DTHs/UEs, and communication of information (including local model parameters from the cluster) from the DTHs/UEs to the MTH/gNB.

In the thus illustrated fourth stage, the MTH/gNB decides on the final cluster heads and informs the thus selected final cluster heads. This basically corresponds to the operation/functionality of step 5 as described above.

As described above, cluster heads can be selected by a two-step approach, i.e. a self-organized selection of temporary cluster heads followed by a central selection of final cluster heads from the temporary cluster heads.

According to at least one exemplifying embodiment, the thus established clustering can then be used for any further operation in the context of federated-learning model training in a wireless communication system. For example, the thus established clustering (by the final cluster heads) can be adopted as a basis for enabling/realizing efficient federated-learning model training in a wireless communication system or, stated in other terms, clustering-based hierarchical federated learning model training (i.e. the first basic aspect or concept as describe above). That is, the operations and functionality as described in connection with FIGS. 1 to 14 can be applied in/on a hierarchical configuration resulting from the application of the operations and functionality as described in connection with FIGS. 15 to 25.

As is evident from the above, particularly FIGS. 22 to 25, exemplifying embodiments may involve specific signaling aspects. For example, referring to the description of steps in connection with FIG. 19, one or more of the following may apply.
In step 1, the DTH/UE initialization and configuration may be based on standardized signaling. This can be implemented e.g. via UE-specific RRC signaling and/or via broadcast signaling.
In step 2, the MTH/gNB may intiate FL steps via UE-specific signaling (e.g. RRC or DCI). In this regard, any specific information or signaling elements according to exemplifying embodiments are accommodated by standardized signaling channels (which may be ML/FL-specific signaling channels).
In steps 3 and 4, the information elements broadcasted by the DTHs/UEs may be delivered through any existing 3GPP sidelink broadcast protocol or any non-3GPP transmission protocol.
In step 5, the MTH/gNB may trigger the collection of further model parameters updates via UE-specific signaling (e.g. RRC or DCI).
In step 6, the MTH/gNB may collect FL model and parameters via UE-specific signaling (e.g. RRC or DCI) from any one of the selected cluster-head DTHs/UEs.

As described above, there are disclosed various exemplifying embodiments for/of broadcast-based clustering for hierarchical federated learning model training.

According to exemplifying embodiments of this basic aspect or concept, a self-organized adaptive approach is presented to allow DTHs decide on whether or not to operate as temporary cluster heads, thereby allowing a more computation/communication efficient federated learning model training.

Besides individual effects and advantages described above in certain contexts, the following effects and advantages can be achieved.

A non-uniform distribution of performance, such as computational power, communication power and battery energy, can be exploited to make federated learning model transfer more computationally efficient and the system/network more sustainable, i.e. to achieve increased efficiency in terms of computation, communication and/or energy respects. A use of local updates on data collected by several DTHs can make data more iid and helps faster aggregated model convergence. Conventional UE D2D or broadcast capabilities, either via 3GPP or non-3GPP technologies, can be leveraged for achieving more efficient federated learning model training

According to at least one exemplifying embodiment, the problem of efficient model collection from DTHs can be solved by utilizing broadcast communication links/channels between DTHs/UEs. With the information received via broadcast, the DTHs evaluate a model similarity metric, and one or more cluster heads are (temporarily) selected in a self-organized manner based on the similarity metric. The (temporary) cluster heads then communicate their similarity metric to the MTH. The MTH uses the collected similarity metrics to build a similarity map (which can be spatial and/or temporal), thereby enabling a more efficient aggregation of the DTH models without any considerable loss of performance.

By virtue of exemplifying embodiments of the present disclosure, as evident from the above, efficient model training, including model collection and/or aggregation, for federated learning, including hierarchical federated learning, in a wireless communication system, can be enabled/realized.

The above-described methods, procedures and functions may be implemented by respective functional elements, entities, modules, units, processors, or the like, as described below.

While in the foregoing exemplifying embodiments of the present invention are described mainly with reference to methods, procedures and functions, corresponding exemplifying embodiments of the present invention also cover respective apparatuses, entities, modules, units, network nodes and/or systems, including both software and/or hardware thereof.

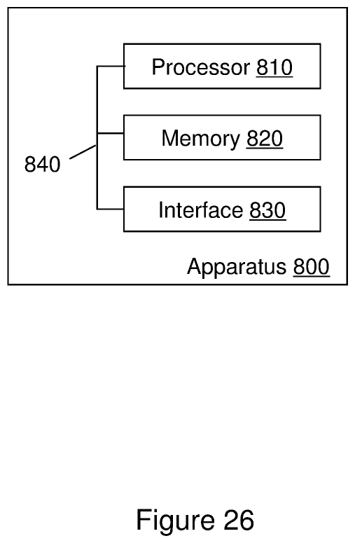

Respective exemplifying embodiments of the present invention are described below referring to FIGS. 26 to 28, while for the sake of brevity reference is made to the detailed description of respective corresponding configurations/setups, schemes, processes, sequences, methods as well as functionalities, principles and operations according to FIGS. 1 to 25.

In FIGS. 26 to 28, the blocks are basically configured to perform respective methods, procedures and/or functions as described above. The entirety of blocks are basically configured to perform the methods, procedures and/or functions as described above, respectively. With respect to FIGS. 26 to 28, it is to be noted that the individual blocks are meant to illustrate respective functional blocks implementing a respective function, process or procedure, respectively. Such functional blocks are implementation-independent, i.e. may be implemented by means of any kind of hardware or software or combination thereof, respectively.

Further, in FIGS. 26 to 28, only those functional blocks are illustrated, which relate to any one of the above-described methods, procedures and/or functions. A skilled person will acknowledge the presence of any other conventional functional blocks required for an operation of respective structural arrangements, such as e.g. a power supply, a central processing unit, respective memories or the like. Among others, one or more memories are provided for storing programs or program instructions for controlling or enabling the individual functional entities or any combination thereof to operate as described herein in relation to exemplifying embodiments.

FIG. 26 shows a schematic diagram illustrating an example of a (constructional) structure of apparatuses according to at least one exemplifying embodiment. Herein, an apparatus can represent a physical entity, i.e. a structural device implementing a specific network element, entity or function or the functionality thereof as such.

As indicated in FIG. 26, according to at least one exemplifying embodiment, an apparatus 800 may comprise at least one processor 810 and at least one memory 820 (and possibly also at least one interface 830), which may be operationally connected or coupled, for example by a bus 840 or the like, respectively.

The processor 810 and/or the interface 830 of the apparatus 800 may also include a modem or the like to facilitate communication over a (hardwire or wireless) link, respectively. The interface 830 of the apparatus 800 may include a suitable transmitter, receiver or transceiver connected or coupled to one or more antennas, antenna units, such as antenna arrays or communication facilities or means for (hardwire or wireless) communications with the linked, coupled or connected device(s), respectively.

The interface 830 of the apparatus 800 is generally configured to communicate with at least one other apparatus, device, node or entity (in particular, the interface thereof). For example, in the configuration of FIG. 1, when the apparatus 800 represents a TH its interface is configured to realize a communication with an apparatus representing a CH and/or an apparatus representing a CTH, when the apparatus 800 represents a CH its interface is configured to realize a communication with an apparatus representing a TH and/or an apparatus representing a CTH, and when the apparatus 800 represents a CTH its interface is configured to realize a communication with an apparatus representing a TH and/or an apparatus representing a CH, as is described in connection with FIG. 1 and/or any one of FIGS. 7 and 11. For example, in the configuration of FIG. 15, when the apparatus 800 represents a TH its interface is configured to realize a communication with an apparatus representing a tCH, when the apparatus 800 represents a tCH its interface is configured to realize a communication with an apparatus representing a TH and/or an apparatus representing a CTH, and when the apparatus 800 represents a CTH its interface is configured to realize a communication with an apparatus representing a tCH, as is described in connection with FIG. 15 and/or any one of FIGS. 22 to 25.

The memory 820 of the apparatus 800 may represent a (non-transitory/tangible) storage medium (e.g. RAM, ROM, EPROM, EEPROM, etc.) and store respective software, programs, program products, macros or applets, etc. or parts of them, which may be assumed to comprise program instructions or computer program code that, when executed by the respective processor, enables the respective electronic device or apparatus to operate in accordance with the exemplifying embodiments of the present invention. Further, the memory 820 of the apparatus 800 may (comprise a database to) store any data, information, or the like, which is used in the operation of the apparatus.

In general terms, respective apparatuses (and/or parts thereof) may represent means for performing respective operations and/or exhibiting respective functionalities, and/or the respective devices (and/or parts thereof) may have functions for performing respective operations and/or exhibiting respective functionalities.

In view of the above, the thus illustrated apparatus 800 is suitable for use in practicing one or more of the exemplifying embodiments, as described herein.

When in the subsequent description it is stated that the processor (or some other means) is configured to perform some function, this is to be construed to be equivalent to a description stating that a (i.e. at least one) processor or corresponding circuitry, potentially in cooperation with a computer program code stored in the memory of the respective apparatus or otherwise available (it should be appreciated that the memory may also be an external memory or provided/realized by a cloud service or the like), is configured to cause the apparatus to perform at least the thus mentioned function. It should be appreciated that herein processors, or more generally processing portions, should not be only considered to represent physical portions of one or more processors, but may also be considered as a logical division of the referred processing tasks performed by one or more processors.

According to the first basic aspect or concept, the apparatus may be configured and/operable according to various exemplifying embodiments as follows.

According to at least one exemplifying embodiment, the thus illustrated apparatus 800 may represent or realize/embody a (part of a) TH or DTH in the configuration of any one of FIGS. 1, 7 and 11. Hence, the apparatus 800 may be configured to perform a procedure and/or exhibit a functionality and/or implement a mechanism, as described (for a TH or DTH) in any one of FIGS. 1 to 14.

Accordingly, the apparatus 800 may be caused or the apparatus 800 or its at least one processor 810 (possibly together with computer program code stored in its at least one memory 820), in its most basic form, is configured to decide on how to perform federated-learning training depending on availability of a cluster head of a cluster of federated-learning training hosts and computation and communication costs for a federated-learning training task, and locally perform the local model training or delegate at least part of a federated-learning training task to the cluster head on the basis of the decision.

According to at least one exemplifying embodiment, the thus illustrated apparatus 800 may represent or realize/embody a (part of a) CH in the configuration of any one of FIGS. 1, 7 and 11. Hence, the apparatus 800 may be configured to perform a procedure and/or exhibit a functionality and/or implement a mechanism, as described (for a CH) in any one of FIGS. 1 to 14.

Accordingly, the apparatus 800 may be caused or the apparatus 800 or its at least one processor 810 (possibly together with computer program code stored in its at least one memory 820), in its most basic form, is configured to obtain a delegation for performing at least part of a federated-learning training task for one or more federated-learning training hosts in the cluster, and perform the at least part of the federated-learning training task for the one or more federated-learning training hosts in the cluster based on the delegation.

According to at least one exemplifying embodiment, the thus illustrated apparatus 800 may represent or realize/embody a (part of a) CTH or MTH in the configuration of any one of FIGS. 1, 7 and 11. Hence, the apparatus 800 may be configured to perform a procedure and/or exhibit a functionality and/or implement a mechanism, as described (for a CTH or MTH) in any one of FIGS. 1 to 14.

Accordingly, the apparatus 800 may be caused or the apparatus 800 or its at least one processor 810 (possibly together with computer program code stored in its at least one memory 820), in its most basic form, is configured to collect at least one of local model parameters of respective local models from one or more federated-learning training hosts and cluster model parameters of respective cluster models from one or more cluster heads of the clusters, a cluster model representing a joint local model for one or more federated-learning training hosts in a respective cluster, and aggregate a global model based on the collected at least one of local model parameters and cluster model parameters.

According to the second basic aspect or concept, the apparatus may be configured and/operable according to various exemplifying embodiments as follows.

According to at least one exemplifying embodiment, the thus illustrated apparatus 800 may represent or realize/embody a (part of a) tCH in the configuration of any one of FIGS. 15 and 22 to 25. Hence, the apparatus 800 may be configured to perform a procedure and/or exhibit a functionality and/or implement a mechanism, as described (for a tCH) in any one of FIGS. 15 to 25.

Accordingly, the apparatus 800 may be caused or the apparatus 800 or its at least one processor 810 (possibly together with computer program code stored in its at least one memory 820), in its most basic form, is configured to receive a set of model parameters of a local model from each of one or more federated-learning training hosts, compute a similarity metric between a locally computed set of model parameters of a local model and each of the received sets of model parameters, decide on whether to operate as a temporary cluster head for the one or more federated-learning training hosts, and communicate the computed similarity metric to a central federated-learning training host configured for global model training when it is decided to operate as the temporary cluster head.

According to at least one exemplifying embodiment, the thus illustrated apparatus 800 may represent or realize/embody a (part of a) TH or DTH in the configuration of any one of FIGS. 15 and 22 to 25. Hence, the apparatus 800 may be configured to perform a procedure and/or exhibit a functionality and/or implement a mechanism, as described (for a TH or DTH) in any one of FIGS. 15 to 25.

Accordingly, the apparatus 800 may be caused or the apparatus 800 or its at least one processor 810 (possibly together with computer program code stored in its at least one memory 820), in its most basic form, is configured to compute a set of model parameters of a local model, and broadcast the computed set of model parameters.

According to at least one exemplifying embodiment, the thus illustrated apparatus 800 may represent or realize/embody a (part of a) CTH or MTH in the configuration of any one of FIGS. 15 and 22 to 25. Hence, the apparatus 800 may be configured to perform a procedure and/or exhibit a functionality and/or implement a mechanism, as described (for a CTH or MTH) in any one of FIGS. 15 to 25.

Accordingly, the apparatus 800 may be caused or the apparatus 800 or its at least one processor 810 (possibly together with computer program code stored in its at least one memory 820), in its most basic form, is configured to receive a similarity metric, indicating a similarity between local model parameters of a number of federated-learning training hosts, from one or more federated-learning training hosts representing temporary cluster heads out of the set of preselected federated-learning training hosts, generate a similarity map for the set of preselected federated-learning training hosts based on the received one or more similarity metrics, and select one or more federated-learning training hosts as cluster heads for collecting local model parameters based on the generated similarity map.

According to at least one exemplifying embodiment, the thus illustrated apparatus 800 may represent or realize/embody a (part of a) CH or MTH or CTH in the configuration of any one of FIGS. 1, 7 and 11. Hence, the apparatus 800 may be configured to perform a procedure and/or exhibit a functionality and/or implement a mechanism, as described (for a CH or MTH or CTH) in FIG. 6.

Accordingly, the apparatus 800 may be caused or the apparatus 800 or its at least one processor 810 (possibly together with computer program code stored in its at least one memory 820), in its most basic form, is configured to acquire information on one or more of computational power, communication power and energy from federated-learning training hosts in cluster, and to select one federated-learning training host as cluster head. Further, such apparatus may further comprise a host information unit/means/circuitry denoted by host information section 931, which represents any implementation for (or configured to) informing (inform) federated-learning training hosts in a cluster about decision (selected cluster head).

As mentioned above, any apparatus according to at least one exemplifying embodiment may be structured by comprising respective units or means for performing corresponding operations, procedures and/or functions. For example, such units or means may be implemented/realized on the basis of an apparatus structure, as exemplified in FIG. 26, i.e. by one or more processors 810, one or more memories 820, one or more interfaces 830, or any combination thereof.

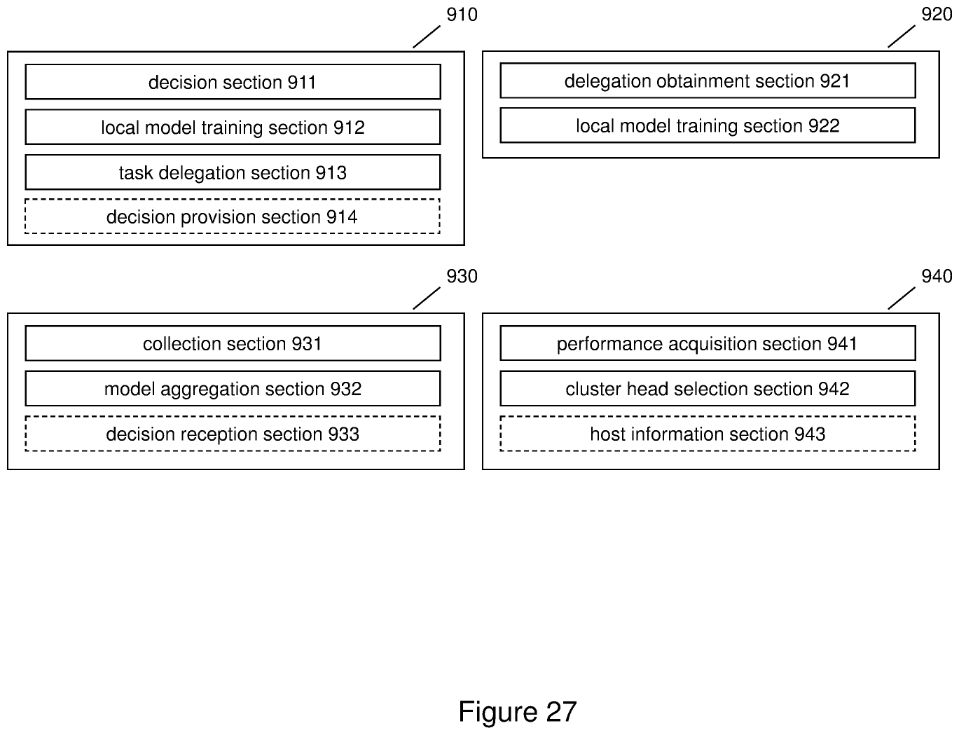

FIG. 27 shows a schematic diagram illustrating an example of a (functional) structure of apparatuses according to at least one exemplifying embodiment.

As shown in FIG. 27, one or more apparatuses according to the first basic aspect or concept may be provided according to various exemplifying embodiments as follows.

As shown in FIG. 27, an apparatus 910 according to at least one exemplifying embodiment may represent or realize/embody a (part of a) TH or DTH in the configuration of any one of FIGS. 1, 7 and 11. Hence, the apparatus 910 may be configured to perform a procedure and/or exhibit a functionality and/or implement a mechanism, as described (for a TH or DTH) in any one of FIGS. 1 to 14.

Such apparatus may comprise (at least) a unit or means for comprise (at least) a decision unit/means/circuitry denoted by decision section 911, which represents any implementation for (or configured to) deciding (decide) on how to perform federated-learning training depending on availability of a cluster head of a cluster of federated-learning training hosts and computation and communication costs for a federated-learning training task, a local model training unit/means/circuitry denoted by local model training section 912, which represents any implementation for (or configured to) locally performing (locally perform) the local model training on the basis of a decision by the decision section, and a task delegation unit/means/circuitry denoted by task delegation section 913, which represents any implementation for (or configured to) delegating at least part of a federated-learning training task to the cluster head on the basis of a decision by the decision section. Further, such apparatus may also comprise a decision provision unit/means/circuitry denoted by decision provision section 914, which represents any implementation for (or configured to) providing (provide) an information about the decision to at least one of the cluster head and a central federated-learning training host configured for global model training.

As shown in FIG. 27, an apparatus 920 according to at least one exemplifying embodiment may represent or realize/embody a (part of a) CH in the configuration of any one of FIGS. 1, 7 and 11. Hence, the apparatus 920 may be configured to perform a procedure and/or exhibit a functionality and/or implement a mechanism, as described (for a CH) in any one of FIGS. 1 to 14.

Such apparatus may comprise (at least) a unit or means for comprise (at least) a delegation obtainment unit/means/circuitry denoted by delegation obtainment section 921, which represents any implementation for (or configured to) obtaining (obtain) a delegation for performing at least part of a federated-learning training task for one or more federated-learning training hosts in the cluster, and a local model training unit/means/circuitry denoted by local model training section 922, which represents any implementation for (or configured to) performing (perform) the at least part of the federated-learning training task for the one or more federated-learning training hosts in the cluster based on the delegation.

As shown in FIG. 27, an apparatus 930 according to at least one exemplifying embodiment may represent or realize/embody a (part of a) CTH or MTH in the configuration of any one of FIGS. 1, 7 and 11. Hence, the apparatus 930 may be configured to perform a procedure and/or exhibit a functionality and/or implement a mechanism, as described (for a CTH or MTH) in any one of FIGS. 1 to 14.

Such apparatus may comprise (at least) a unit or means for comprise (at least) a collection unit/means/circuitry denoted by collection section 931, which represents any implementation for (or configured to) collecting (collect) at least one of local model parameters of respective local models from one or more federated-learning training hosts and cluster model parameters of respective cluster models from one or more cluster heads of the clusters, a cluster model representing a joint local model for one or more federated-learning training hosts in a respective cluster, and a model aggregation unit/means/circuitry denoted by model aggregation section 932, which represents any implementation for (or configured to) aggregating (aggregate) a global model based on the collected at least one of local model parameters and cluster model parameters.

As shown in FIG. 27, an apparatus 940 according to at least one exemplifying embodiment may represent or realize/embody a (part of a) CH or MTH or CTH in the configuration of any one of FIGS. 1, 7 and 11. Hence, the apparatus 940 may be configured to perform a procedure and/or exhibit a functionality and/or implement a mechanism, as described (for a CH or MTH or CTH) in FIG. 6.

Such apparatus may comprise (at least) a unit or means for comprise (at least) a performance acquisition unit/means/circuitry denoted by performance acquisition section 941, which represents any implementation for (or configured to) acquiring (acquire) information on one or more of computational power, communication power and energy from federated-learning training hosts in cluster, and a cluster head selection unit/means/circuitry denoted by cluster head selection section 942, which represents any implementation for (or configured to) selecting (select) one federated-learning training host as cluster head. Further, such apparatus may further comprise a host information unit/means/circuitry denoted by host information section 931, which represents any implementation for (or configured to) informing (inform) federated-learning training hosts in a cluster about decision (selected cluster head).

For further details regarding the operability/functionality of the apparatuses (or units/means thereof) according to exemplifying embodiments, as shown in FIG. 27, reference is made to the above description in connection with any one of FIGS. 1 to 14, respectively.

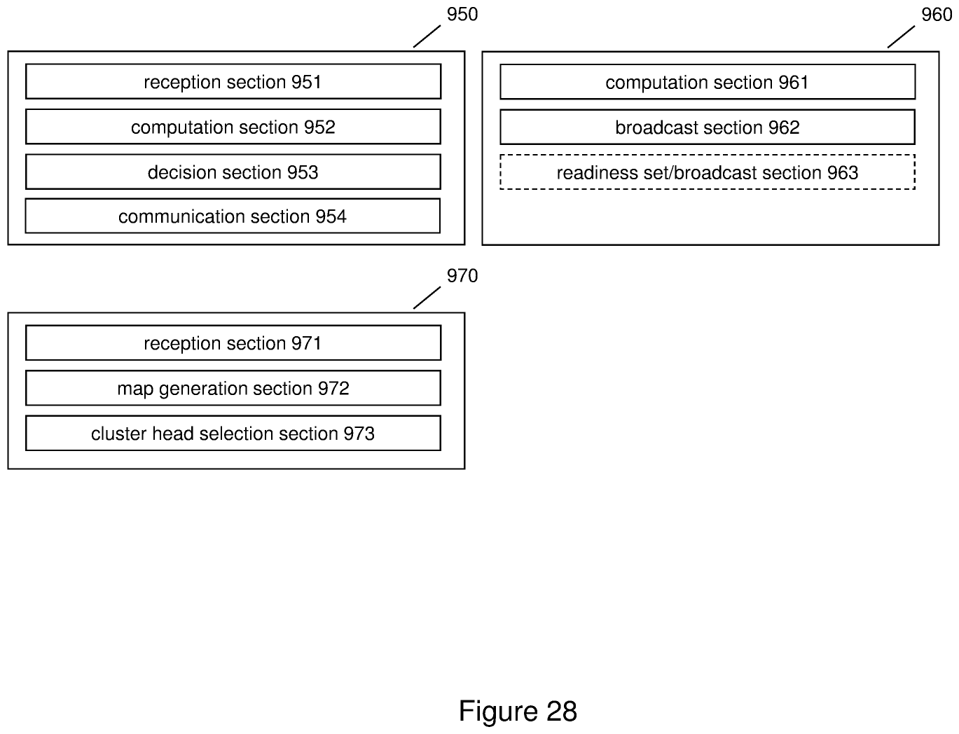

FIG. 28 shows a schematic diagram illustrating an example of a (functional) structure of apparatuses according to at least one exemplifying embodiment.

As shown in FIG. 28, one or more apparatuses according to the second basic aspect or concept may be provided according to various exemplifying embodiments as follows.

As shown in FIG. 28, an apparatus 950 according to at least one exemplifying embodiment may represent or realize/embody a (part of a) tCH in the configuration of any one of FIGS. 15 and 22 to 25. Hence, the apparatus 950 may be configured to perform a procedure and/or exhibit a functionality and/or implement a mechanism, as described (for a tCH) in any one of FIGS. 15 to 25.

Such apparatus may comprise (at least) a unit or means for comprise (at least) a reception unit/means/circuitry denoted by reception section 951, which represents any implementation for (or configured to) receiving (receive) a set of model parameters of a local model from each of one or more federated-learning training hosts, a computation unit/means/circuitry denoted by computation section 952, which represents any implementation for (or configured to) computing (compute) a similarity metric between a locally computed set of model parameters of a local model and each of the received sets of model parameters, a decision unit/means/circuitry denoted by decision section 953, which represents any implementation for (or configured to) deciding/decide) on whether to operate as a temporary cluster head for the one or more federated-learning training hosts, and a communication unit/means/circuitry denoted by communication section 954, which represents any implementation for (or configured to) communicating (communicate) the computed similarity metric to a central federated-learning training host configured for global model training when it is decided to operate as the temporary cluster head.

As shown in FIG. 28, an apparatus 960 according to at least one exemplifying embodiment may represent or realize/embody a (part of a) TH or DTH in the configuration of any one of FIGS. 15 and 22 to 25. Hence, the apparatus 960 may be configured to perform a procedure and/or exhibit a functionality and/or implement a mechanism, as described (for a TH or DTH) in any one of FIGS. 15 to 25.

Such apparatus may comprise (at least) a unit or means for comprise (at least) a computation unit/means/circuitry denoted by computation section 961, which represents any implementation for (or configured to) computing (compute) a set of model parameters of a local model, and a broadcast unit/means/circuitry denoted by broadcast section 962, which represents any implementation for (or configured to) broadcasting (broadcast) the computed set of model parameters. Also, such apparatus may further comprise a readiness set/broadcast unit/means/circuitry denoted by readiness set/broadcast section 963, which represents any implementation for (or configured to) setting and/or broadcasting (set and/r broadcast) a readiness index indicating a readiness for operating as temporary cluster head.

As shown in FIG. 28, an apparatus 970 according to at least one exemplifying embodiment may represent or realize/embody a (part of a) CTH or MTH in the configuration of any one of FIGS. 15 and 22 to 25. Hence, the apparatus 970 may be configured to perform a procedure and/or exhibit a functionality and/or implement a mechanism, as described (for a CTH or MTH) in any one of FIGS. 15 to 25.

Such apparatus may comprise (at least) a unit or means for comprise (at least) a reception unit/means/circuitry denoted by reception section 971, which represents any implementation for (or configured to) receiving (receive) a similarity metric, indicating a similarity between local model parameters of a number of federated-learning training hosts, from one or more federated-learning training hosts representing temporary cluster heads out of the set of preselected federated-learning training hosts, a map generation unit/means/circuitry denoted by map generation section 972, which represents any implementation for (or configured to) generating (generate) a similarity map for the set of preselected federated-learning training hosts based on the received one or more similarity metrics, and a cluster head selection unit/means/circuitry denoted by cluster head selection section 973, which represents any implementation for (or configured to) selecting (select) one or more federated-learning training hosts as cluster heads for collecting local model parameters based on the generated similarity map.

For further details regarding the operability/functionality of the apparatuses (or units/means thereof) according to exemplifying embodiments, as shown in FIG. 28, reference is made to the above description in connection with any one of FIGS. 15 to 25, respectively.

According to exemplifying embodiments of the present disclosure, any one of the (at least one) processor, the (at least one) memory and the (at least one) interface, as well as any one of the illustrated units/means, may be implemented as individual modules, chips, chipsets, circuitries or the like, or one or more of them can be implemented as a common module, chip, chipset, circuitry or the like, respectively.

According to exemplifying embodiments of the present disclosure, a system may comprise any conceivable combination of any depicted or described apparatuses and other network elements or functional entities, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, a basic system architecture of a (tele)communication network including a mobile communication system where some examples of exemplifying embodiments are applicable may include an architecture of one or more communication networks including wireless access network sub-/system(s) and possibly core network(s). Such an architecture may include one or more communication network control elements or functions, such as e.g. access network elements, radio access network elements, access service network gateways or base transceiver stations, like a base station, an access point, a NodeB (NB), an eNB or a gNB, a distributed or a centralized unit, which controls a respective coverage area or cell(s) and with which one or more communication stations such as communication elements or functions, like user devices or terminal devices, like a UE, or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The general functions and interconnections of the described elements and functions, which also depend on the actual network type, are known to those skilled in the art and described in corresponding specifications, so that a detailed description thereof is omitted herein. It should be appreciated that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of exemplifying embodiments may also be able to communicate with other networks, such as a public switched telephone network or the Internet, including the Internet-of-Things. The communication network may also be able to support the usage of cloud services for virtual network elements or functions thereof, wherein it is to be noted that the virtual network part of the (tele)communication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g. a cloud infrastructure.

Any method step is suitable to be implemented as software or by hardware without changing the idea of the present disclosure. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or units/means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for enabling/realizing efficient model training, including model collection and/or aggregation, for federated learning, including hierarchical federated learning, in a wireless communication system. Such measures exemplarily comprise that a federated-learning training host configured for local model training decides on how to perform the local model training depending on availability of a cluster head and computation and communication costs for local model training, and either locally performs the local model training or delegates at least part of the local model training to the cluster head. Also, such measures exemplarily comprise that a federated-learning training host configured for local model training computes a similarity metric between a locally computed set of local model parameters and each the received sets of local model parameters, and decides on whether to operate as a temporary cluster head for one or more federated-learning training hosts.

Even though the present disclosure is described above with reference to the examples according to the accompanying drawings, it is to be understood that the present disclosure is not restricted thereto. Rather, it is apparent to those skilled in the art that the present disclosure can be modified in many ways without departing from the scope of the inventive idea as disclosed herein.

### List of Acronyms and Abbreviations

3GPP 3rd Generation Partnership Project
5G 5^{th} Generation
CH Cluster Head
CTH Central (FL) Training Host
D2D Device-to-Device
DCI Downlink Control Information
DTH Distributed (FL) Training Host
eMBMS evolved Multimedia Broadcast Multicast Service
FL Federated Learning
GNSS Global Navigation Satellite System
gNB Next generation NodeB (5G/NR base station)
gNB-CU gNB—Central Unit
gNB-DU gNB—Distributed Unit
MIMO Multiple Input Multiple Output
ML Machine Learning
MTH Meta (FL) Training Host
NR New Radio
RAN Radio Access Network
RIC RAN Intelligent Controller
RRC Radio Resource Control
RRM Radio Resource Management
SDAP Service Data Adaptation Protocol
TH (FL) Training Host
tCH temporary Cluster Head
UE User Equipment

1. A method of a communication entity in a wireless communication system, which is configured to act as a federated-learning training host configured for local model training, the method comprising:
deciding on how to perform federated-learning training depending on availability of a cluster head of a cluster of federated-learning training hosts and computation and communication costs for a federated-learning training task, and
locally performing the local model training or delegating at least part of a federated-learning training task to the cluster head on the basis of the decision.

2. The method according to claim 1, the delegating comprising at least one of:
delegating, to the cluster head, cluster model computation and cluster model communication to a central federated-learning training host configured for global model training, and
delegating, to the cluster head, cluster model parameter averaging and cluster model communication to a central federated-learning training host configured for global model training,
wherein the delegating comprises communicating at least one of a local data set for local model training and computed model parameters of a local model to the cluster head via device-to-device and/or sidelink communication.

3. (canceled)

4. The method according to claim 1, wherein
the deciding comprises determining whether the cluster head is available, and
the local model training is locally performed when the cluster head is not available,
wherein the cluster head is determined to be available when the cluster of federated-learning training hosts exists, in which said communication entity is a cluster member as one of the federated-learning training hosts, and a communication entity acting as the cluster head is reachable for said communication entity.

5. (canceled)

6. The method according to claim 1, wherein
the computation and communication costs for a federated-learning training task comprise computation and communication costs for local training and computation and communication costs for delegation,
the computation and communication costs for local training comprise a sum of a cost for computing model parameters of the local model and a cost for communicating the computed model parameters of the local model to a central federated-learning training host configured for global model training, and
the computation and communication costs for delegation comprise first type delegation costs, which comprise a cost for communicating a local data set for local model training to the cluster head, and second type delegation costs, which comprise a sum of a cost for computing model parameters of the local model and a cost for communicating the computed model parameters of the local model to the cluster head, or a minimum of the first type delegation costs and the second type delegation costs.

7. The method according to claim 6, wherein
the deciding comprises comparing the computation and communication costs for local training with the computation and communication costs for delegation, and
the local model training is locally performed when the computation and communication costs for local training are equal or lower, or at least part of the federated-learning training task is delegated to the cluster head when the computation and communication costs for delegation are lower.

8. The method according to claim 6, wherein
the deciding comprises comparing the first type delegation costs and the second type delegation costs,
a first type delegation is performed, wherein cluster model computation and cluster model communication to a central federated-learning training host configured for global model training is delegated to the cluster head, when the first type delegation costs are lower, or a second type delegation is performed, wherein cluster model parameter averaging and cluster model communication to a central federated-learning training host configured for global model training is delegated to the cluster head, when the second type delegation costs are equal or lower, and wherein
in the first type delegation, a local data set for local model training is communicated to the cluster head, and
in the second type delegation, model parameters of the local model are computed and the computed model parameters of the local model are communicated to the cluster head.

9. (canceled)

10. The method according to claim 1, further comprising:
providing an information about the decision to at least one of the cluster head and a central federated-learning training host configured for global model training,
said information comprising one or more of:
an identification of the cluster head when it is decided to delegate at least part of the federated-learning training task to the cluster head,
an indication of a lack of necessity or desire of receiving an at least partially aggregated model from the central federated-learning training host when cluster model computation and cluster model communication to the central federated-learning training host is delegated to the cluster head, and
an indication of necessity or desire of receiving an at least partially aggregated model from the central federated-learning training host when cluster model parameter averaging and cluster model communication to the central federated-learning training host is delegated to the cluster head.

11. (canceled)

12. The method according to claim 10, said information being provided by at least one of radio resource signaling and medium access control signaling towards the central federated-learning training host.

13. The method according to claim 1, wherein
the cluster of federated-learning training hosts is a group of communication entities having a predefined level of trust for mutual data sharing.

14. The method according to claim 1, wherein
said method is executed in a round of synchronous model collection by a central federated-learning training host configured for global model training, or
said method is executed in an event of asynchronous model collection by a central federated-learning training host configured for global model training.

15. The method according to claim 1, wherein
said communication entity is or comprises a communication element or function, such as a user equipment or part thereof, the cluster head is or comprises a communication element or function, such as a user equipment or part thereof, and a central federated-learning training host is or comprises a communication control element or function, such as a base station or Node B, or
said communication entity is or comprises a communication element or function, such as a user equipment or part thereof, the cluster head is or comprises a distributed unit of a communication control element or function, such as a base station or Node B, and a central federated-learning training host is or comprises a central unit of a communication control element or function, such as a base station or Node B, or a radio access network controller element or function, such as a RAN intelligent controller.

16. (canceled)

17. A method of a communication entity in a wireless communication system, which is configured to act as a cluster head of a cluster of federated-learning training hosts each being configured for local model training, the method comprising:
obtaining a delegation for performing at least part of a federated-learning training task for one or more federated-learning training hosts in the cluster, and
performing the at least part of the federated-learning training task for the one or more federated-learning training hosts in the cluster based on the delegation.

18.-28. (canceled)

29. A method of a communication entity in a wireless communication system, which is configured to act as a central federated-learning training host configured for global model training for one or more clusters of federated-learning training hosts each being configured for local model training, the method comprising:
collecting at least one of local model parameters of respective local models from one or more federated-learning training hosts and cluster model parameters of respective cluster models from one or more cluster heads of the clusters, a cluster model representing a joint local model for one or more federated-learning training hosts in a respective cluster, and
aggregating a global model based on the collected at least one of local model parameters and cluster model parameters.

30. The method according to claim 29, further comprising:
receiving, from one or more federated-learning training hosts, an information about a decision on whether the local model training is locally performed or at least part of a federated-learning training task is delegated to a cluster head of a cluster, in which the respective federated-learning training host is a cluster member.

31. The method according to claim 30, said information being received by at least one of radio resource signaling and medium access control signaling.

32. The method according to claim 30, said information comprising one or more of:
an identification of the cluster head when it is decided to delegate at least part of the federated-learning training task to the cluster head,
an indication of a lack of necessity or desire of receiving an at least partially aggregated model when cluster model computation and cluster model communication is delegated to the cluster head, and
an indication of necessity or desire of receiving an at least partially aggregated model when cluster model parameter averaging and cluster model communication is delegated to the cluster head.

33. The method according to claim 31, further comprising:
providing an at least partially aggregated model to each federated-learning training host from which an indication of necessity or desire of receiving an at least partially aggregated model is received.

34. The method according to claim 33, said at least partially aggregated model being provided by service data adaptation protocol signaling.

35. The method according to claim 29, wherein
said method is executed in a round of synchronous model collection, or
said method is executed in an event of asynchronous model collection.

36. The method according to claim 29, wherein
said communication entity is or comprises a communication control element or function, such as a base station or Node B, each of the federated-learning training hosts is or comprises a communication element or function, such as a user equipment or part thereof, and each of the cluster heads is or comprises a communication element or function, such as a user equipment or part thereof, or
said communication entity is or comprises a central unit of a communication control element or function, such as a base station or Node B, or a radio access network controller element or function, such as a RAN intelligent controller, each of the federated-learning training hosts is or comprises a communication element or function, such as a user equipment or part thereof, and each of the cluster heads is or comprises a distributed unit of a communication control element or function, such as a base station or Node B.

37. (canceled)

38. An apparatus of a communication entity in a wireless communication system, which is configured to act as a federated-learning training host configured for local model training,
the apparatus comprising at least one processor and at least one memory including computer program code, wherein the at least one processor, with the at least one memory and the computer program code, is configured to cause the apparatus to perform:
deciding on how to perform federated-learning training depending on availability of a cluster head of a cluster of federated-learning training hosts and computation and communication costs for a federated-learning training task, and
locally performing the local model training or delegating at least part of a federated-learning training task to the cluster head on the basis of the decision.

39.-53. (canceled)

54. An apparatus of a communication entity in a wireless communication system, which is configured to act as a cluster head of a cluster of federated-learning training hosts each being configured for local model training,
the apparatus comprising at least one processor and at least one memory including computer program code, wherein the at least one processor, with the at least one memory and the computer program code, is configured to cause the apparatus to perform:
obtaining a delegation for performing at least part of a federated-learning training task for one or more federated-learning training hosts in the cluster, and
performing the at least part of the federated-learning training task for the one or more federated-learning training hosts in the cluster based on the delegation.

55.-65. (canceled)

66. An apparatus of a communication entity in a wireless communication system, which is configured to act as a central federated-learning training host configured for global model training for one or more clusters of federated-learning training hosts each being configured for local model training,
the apparatus comprising at least one processor and at least one memory including computer program code, wherein the at least one processor, with the at least one memory and the computer program code, is configured to cause the apparatus to perform:
collecting at least one of local model parameters of respective local models from one or more federated-learning training hosts and cluster model parameters of respective cluster models from one or more cluster heads of the clusters, a cluster model representing a joint local model for one or more federated-learning training hosts in a respective cluster, and
aggregating a global model based on the collected at least one of local model parameters and cluster model parameters.

67.-74. (canceled)

75. A non-transitory computer-readable medium, on which computer-executable computer program code is stored, which, when executed on a computer, is configured to cause the computer to carry out the method according to claim 1.

76.-136. (canceled)
